(19) United States
(12) Patent Application Publication
(10) Pub. No.: US 2009/0012233 A1
(43) Pub. Date: Jan. 8, 2009

(54) Epoxy Resin Molding Material for Sealing and Electronic Component Device

(76) Inventors: Mitsuyoshi Hamada, Chiba (JP); Akira Nagai, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/161,839

(22) PCT Filed: Jan. 23, 2007
(86) PCT No.: PCT/JP2007/050935

§ 371 Date: Jul. 23, 2008

(30) Foreign Application Priority Data
Jan. 23, 2006 (JP) P2006-013852
Apr. 9, 2006 (JP) P2006-238951

(51) Int. Cl. C08L 63/10; C08L 63/00

(52) U.S. Cl. 524/612; 525/523

(57) ABSTRACT

The present invention relates to an epoxy resin molding material for sealing, comprising an epoxy resin (A), a curing agent (B) and an acrylic compound (C), wherein the acrylic compound (C) is an acrylic compound obtained by polymerizing compounds represented respectively by the following general formulae (I) and (II) in a (I)/(II) mass ratio of from 0 to 10. The present invention provides an epoxy resin molding material for sealing, which is excellent in fluidity and reflow soldering resistance without reducing curability, as well as an electronic component device comprising an element sealed therewith.

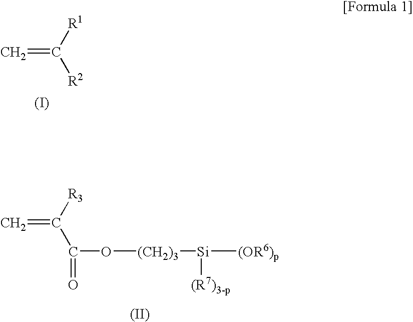

wherein R¹ represents a hydrogen atom or a methyl group, and R² represents a silicon atom-free monovalent organic group, R³ represents a hydrogen atom or a methyl group, R⁶ represents a hydrogen atom or a hydrocarbon group having 1 to 6 carbon atoms, R⁷ represents a hydrocarbon group having 1 to 6 carbon atoms, and p is an integer of 1 to 3.

### TECHNICAL FIELD

The present invention relates to an epoxy resin molding material for sealing and an electronic component device comprising an element sealed with the molding material.

### BACKGROUND ART

Epoxy resin molding materials have been widely used in the field of sealing electronic components such as transistors, IC, etc. This is because the epoxy resin is well-balanced in various properties such as electrical property, humidity resistance, heat resistance, mechanical property, and adhesive property to inserted articles. Particularly a combination of an o-cresol novolac epoxy resin and a novolac type phenol curing agent is especially well-balanced in these properties, and has been used as the main base resin for molding materials for sealing.

As downsizing, weight-saving and performance of electronic devices are advancing in recent years, the mounting thereof at a higher density is progressing, and the common configuration for these electronic component devices is changing from conventional pin insertion-type packages to surface-mounted packages. When a semiconductor device is attached to a circuit board, the conventional pin insertion-type package is not exposed directly to high temperature because the back of the circuit board is soldered after pins are inserted into the circuit board. However, the surface-mounted package is exposed directly to a soldering temperature because the whole of the semiconductor device is treated in a solder bath or in a reflow apparatus. As a result, the package upon moisture absorption will cause detachment of the adhesive interface and cracking of the package during soldering due to rapid expansion of absorbed moisture, to show a problem of reduction in the reliability of the package at the time of mounting.

To solve the above problem, a method for moisture-proof packing of ICs or a method of using previously sufficiently dried ICs before mounting on circuit boards is used to reduce adsorbed moisture in semiconductor devices (see, for example, “Mounting Technology of Surface-Mounted LSI Package and Improvements in Its Reliability”, pp. 254-256, Nov. 16, 1988, Oyo Gijutsu Shuppan, edited by Semiconductor Division in Hitachi, Ltd.), but these methods are troublesome and costs are increased. Another countermeasure includes a method of increasing the content of fillers by which adsorbed moisture in semiconductor devices is decreased, but in this method, there is a problem of causing significant reduction in fluidity. As a method of increasing the content of fillers without deteriorating the fluidity of epoxy resin molding materials, a method of optimizing the particle-size distribution of fillers has been proposed (see, for example, JP-A No. 06-224328). When the fluidity of epoxy resin molding materials for sealing is low, there arise new problems such as gold wire flow and generation of voids and pinholes at the time of molding (see, for example, “High Reliability for Semiconductor Sealing Resin”, pp. 172-176, Jan. 31, 1990, edited by Technical Information Institute Co., Ltd.).

### DISCLOSURE OF INVENTION

As described above, low fluidity causes new problems, and there is demand for improvement in fluidity without reducing curability. However, a sufficient effect on improvement in fluidity cannot be achieved by the method of optimizing the particle-size distribution of fillers.

The present invention was made in view of such circumstances, and the object of the present invention is to provide an epoxy resin molding material for sealing, which is excellent in fluidity and reflow soldering resistance without reducing curability, as well as an electronic component device comprising an element sealed therewith.

(1) The present invention relates to an epoxy resin molding material for sealing, comprising an epoxy resin (A), a curing agent (B) and an acrylic compound (C), wherein the acrylic compound (C) is an acrylic compound obtained by polymerizing compounds represented respectively by the following general formulae (I) and (II) in a (I)/(II) mass ratio of from 0 to 10,

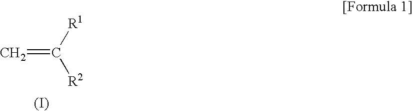

wherein R¹ represents a hydrogen atom or a methyl group, and R² represents a silicon atom-free monovalent organic group,

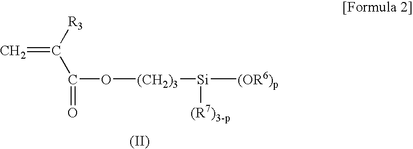

wherein R³ represents a hydrogen atom or a methyl group, R⁶ represents a hydrogen atom or a hydrocarbon group having 1 to 6 carbon atoms, R⁷ represents a hydrocarbon group having 1 to 6 carbon atoms, and p is an integer of 1 to 3.

(2) The present invention relates to the epoxy resin molding material for sealing according to above-mentioned (1), wherein R² in the general formula (I) is a group represented by the general formula (III) below, a —CO—NH₂ group, a —CN group, an alkyl group, an alkenyl group, a cycloalkenyl group, an aryl group, an aldehyde group, a hydroxyalkyl group, a carboxyalkyl group, a hydrocarbon group having 1 to 6 carbon atoms that is bound via an amide structure, a monovalent heterocyclic group, an organic group bound via a divalent or trivalent heteroatom, or a group having a hydrocarbon group bound via a divalent or trivalent heteroatom to an organic group, and may be substituted,

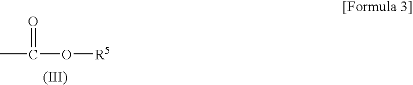

wherein R⁵ represents a hydrogen atom, an alkali metal atom or a substituted or unsubstituted organic group having 1 to 22 carbon atoms.

(3) The present invention relates to the epoxy resin molding material for sealing according to above-mentioned (2), wherein R⁵ in the general formula (III) is a hydrocarbon group wherein at least a part of hydrogen atoms may be substituted by a chlorine atom, a fluorine atom, an amino group, an amine salt, an amido group, an isocyanato group, an alkyloxide group, a glycidyl group, an aziridine group, a hydroxyl group, an alkoxy group, an acetoxy group or an acetacetoxy group.

(4) The present invention relates to the epoxy resin molding material for sealing according to above-mentioned (1) or (2), wherein the compound represented by the general formula (I) is an ester of a substituted or unsubstituted divalent or more alcohol and acrylic acid or methacrylic acid.

(5) The present invention relates to the epoxy resin molding material for sealing according to any one of the above-mentioned (1) to (4), wherein the proportion of the acrylic compound (C) in the epoxy resin molding material for sealing is 0.03 to 0.8% by mass.

(6) The present invention relates to the epoxy resin molding material for sealing according to any one of the above-mentioned (1) to (5), wherein the epoxy resin comprises at least one member selected from the group consisting of a biphenyl type epoxy resin, thiodiphenol type epoxy resin, novolac type epoxy resin, dicyclopentadiene type epoxy resin, naphthalene type epoxy resin, triphenylmethane type epoxy resin, bisphenol F type epoxy resin, phenol-aralkyl type epoxy resin, and naphthol-aralkyl type epoxy resin.

(7) The present invention relates to the epoxy resin molding material for sealing according to any one of the above-mentioned (1) to (6), wherein the curing agent (B) comprises at least one member selected from the group consisting of a phenol-aralkyl resin, naphthol-aralkyl resin, triphenylmethane type phenol resin, novolac type phenol resin, and copolymer type phenol-aralkyl resin.

(8) The present invention relates to the epoxy resin molding material for sealing according to any one of the above-mentioned (1) to (7), which further comprises a silane compound (D).

(9) The present invention relates to the epoxy resin molding material for sealing according to any one of the above-mentioned (1) to (8), which further comprises a curing accelerator (E).

(10) The present invention relates to the epoxy resin molding material for sealing according to any one of the above-mentioned (1) to (9), which further comprises an inorganic filler (F).

(11) The present invention relates to an electronic component device comprising an element sealed with the epoxy resin molding material for sealing according to any one of the above-mentioned (1) to (10).

The disclosure of this application is related to the subject matter of Japanese Patent Application Nos. 2006-013852 and 2006-238951 filed Jan. 23, 2006 and Sep. 4, 2006, respectively, the disclosure of which is incorporated herein by reference.

### BEST MODE FOR CARRYING OUT THE PRESENT INVENTION

The epoxy resin (A) used in the present invention is not particularly limited as long as the epoxy resin has two or more epoxy groups in one molecule thereof. Examples thereof include epoxidation products of novolac resins (for example, phenolic novolac type epoxy resins, ortho-cresol novolac type epoxy resins, and triphenylmethane skeleton-containing epoxy resins), which are prepared by condensation or co-condensation of a phenol such as phenol, cresol, xylenol, resorcin, catechol, bisphenol A or bisphenol F and/or a naphthol such as α-naphthol, β-naphthol or dihydroxynaphthalene, with an aldehyde group-containing compound such as formaldehyde, acetaldehyde, propionaldehyde, benzaldehyde or salicylaldehyde, in the presence of an acid catalyst; diglycidyl ethers such as alkyl-substituted, aromatic ring-substituted or unsubstituted bisphenol A, bisphenol F, bisphenol S, biphenols or thiodiphenols; stilbene type epoxy resins; hydroquinone type epoxy resins; glycidyl ester type epoxy resins obtained by reaction of a polybasic acid such as phthalic acid or dimer acid with epichlorohydrin; glycidylamine type epoxy resins obtained by reaction of a polyamine such as diaminodiphenylmethane or isocyanuric acid with epichlorohydrin; epoxidation products of a cocondensation resin from dicyclopentadiene and phenols; epoxy resins containing a naphthalene ring; epoxidation products of aralkyl type phenol resins such as phenol-aralkyl resins or naphthol-aralkyl resins synthesized from phenols and/or naphthols and dimethoxyparaxylene or bis(methoxymethyl)biphenyl; trimethylolpropane type epoxy resins; terpene modification epoxy resins; linear aliphatic epoxy resins obtained by oxidation of an olefin bond with a peracid such as peracetic acid; alicyclic epoxy resins; and the like, and these resins may be used alone or in combination of two or more thereof.

Among them, biphenyl type epoxy resins which are diglycidyl ethers of alkyl-substituted, aromatic ring-substituted or unsubstituted biphenols are preferably contained from the viewpoint of achieving both fluidity and curability; novolac type epoxy resins are preferably contained from the viewpoint of curability; dicyclopentadiene type epoxy resins are preferably contained from the viewpoint of low hygroscopicity; naphthalene type epoxy resins and/or triphenylmethane type epoxy resins are preferably contained from the viewpoint of heat resistance and low warpage; bisphenol F type epoxy resins which are diglycidyl ethers of alkyl-substituted, aromatic ring-substituted or unsubstituted bisphenol F are preferably contained from the viewpoint of achieving both fluidity and flame retardancy; thiodiphenol type epoxy resins which are diglycidyl ethers of alkyl-substituted, aromatic ring-substituted or unsubstituted thiodiphenols are preferably contained from the viewpoint of achieving both fluidity and reflow; epoxidation products of phenol-aralkyl resins synthesized from alkyl-substituted, aromatic ring-substituted or unsubstituted phenols and bis(methoxymethyl)biphenyl are preferably contained from the viewpoint of achieving both curability and flame retardancy; and epoxidation products of naphthol-aralkyl resins synthesized from alkyl-substituted, aromatic ring-substituted or unsubstituted naphthols and dimethoxyparaxylene are preferably contained from the viewpoint of achieving both storage stability and flame retardancy.

Examples of the biphenyl type epoxy resins include epoxy resins represented by the following general formula (V):

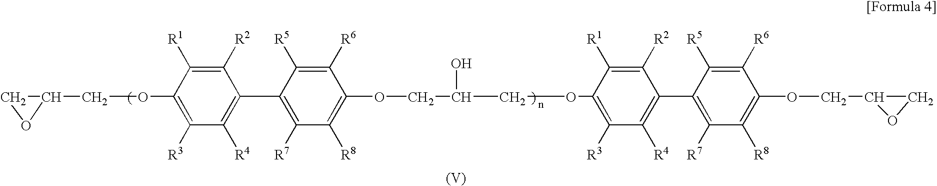

wherein R¹ to R⁸ are selected from a hydrogen atom and substituted or unsubstituted monovalent hydrocarbon groups having 1 to 10 carbon atoms, and may be the same as or different from one another, and n is either 0 or an integer of 1 to 3.

The biphenyl type epoxy resins represented by the general formula (V) are obtained by reacting epichlorohydrin with a biphenol compound using a conventional method. Examples of R¹ to R⁸ in the general formula (V) include a hydrogen atom, an alkyl group having 1 to 10 carbon atoms such as a methyl group, an ethyl group, a propyl group, a butyl group, an isopropyl group, an isobutyl group, or a tert-butyl group, and an alkenyl group having 1 to 10 carbon atoms such as a vinyl group, an allyl group or a butenyl group, among which a hydrogen atom or a methyl group is preferred. Examples of this type of epoxy resin include epoxy resins comprising 4,4′-bis(2,3-epoxypropoxy)biphenyl or 4,4′-bis(2,3-epoxypropoxy)-3,3′,5,5′-tetra methylbiphenyl as the principal component, as well as epoxy resins obtained by the reaction of epichlorohydrin with either 4,4′-biphenol or 4,4′-(3,3′,5,5′-tetra methyl)biphenol. Of these, epoxy resins comprising 4,4′-bis(2,3-epoxypropoxy)-3,3′,5,5′-tetra methylbiphenyl as the principal component are particularly preferred. This type of epoxy resin is available as a commercial product under the trade name YX-4000 manufactured by Japan Epoxy Resins Co., Ltd. The amount of the biphenyl type epoxy resin incorporated is preferably 20% by mass or more, more preferably 30% by mass or more, even more preferably 50% by mass or more, based on the total amount of the epoxy resins, in order to exhibit its performance.

Examples of the thiodiphenol type epoxy resins include epoxy resins represented by the following general formula (VI):

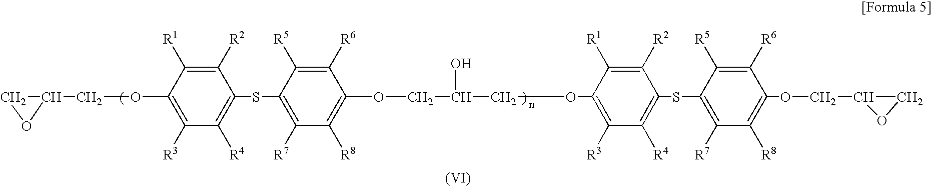

wherein R¹ to R⁸ are selected from a hydrogen atom and substituted or unsubstituted monovalent hydrocarbon groups having 1 to 10 carbon atoms, and may be the same as or different from one another, and n is either 0 or an integer of 1 to 3.

The thiodiphenol type epoxy resins represented by the general formula (VI) are obtained by reacting epichlorohydrin with a thiodiphenol compound using a conventional method. Examples of R¹ to R⁸ in the general formula (VI) include a hydrogen atom, an alkyl group having 1 to 10 carbon atoms such as a methyl group, an ethyl group, a propyl group, a butyl group, an isopropyl group, an isobutyl group or a tert-butyl group, and an alkenyl group having 1 to 10 carbon atoms such as a vinyl group, an allyl group or a butenyl group, among which a hydrogen atom, a methyl group or a tert-butyl group is preferred. Examples of this type of epoxy resin include epoxy resins comprising the diglycidyl ether of 4,4′-dihydroxydiphenyl sulfide as the principal component, as well as epoxy resins comprising the diglycidyl ether of 2,2′,5,5′-tetra methyl-4,4′-dihydroxydiphenyl sulfide as the principal component and epoxy resins comprising the diglycidyl ether of 2,2′-dimethyl-4,4′-dihydroxy-5,5′-di-tert-butyldiphenyl sulfide as the principal component. Of these, epoxy resins comprising the diglycidyl ether of 2,2′-dimethyl-4,4′-dihydroxy-5,5′-di-tert-butyldiphenyl sulfide as the principal component are particularly preferred. This type of epoxy resin is available as a commercial products under the trade name YSLV-120TE manufactured by Nippon Steel Chemical Group. The amount of the thiodiphenol type epoxy resin incorporated is preferably 20% by mass or more, more preferably 30% by mass or more, even more preferably 50% by mass or more, based on the total amount of the epoxy resins, in order to exhibit its performance.

Examples of the bisphenol F type epoxy resins include epoxy resins represented by the following general formula (VII):

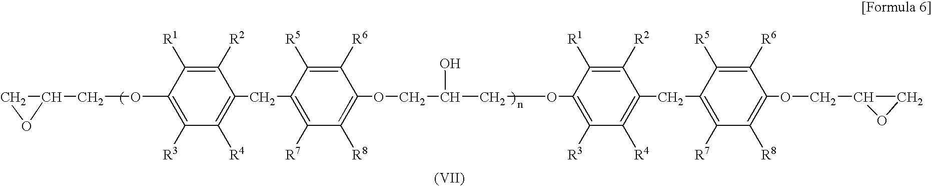

wherein R¹ to R⁸ are selected from a hydrogen atom and substituted or unsubstituted monovalent hydrocarbon groups having 1 to 10 carbon atoms, and may be the same as or different from one another, and n is either 0 or an integer of 1 to 3.

The bisphenol F type epoxy resins represented by the general formula (VII) are obtained by reacting epichlorohydrin with a biphenol F compound using a conventional method. Examples of R¹ to R⁸ in the general formula (VII) include a hydrogen atom, an alkyl group having 1 to 10 carbon atoms such as a methyl group, an ethyl group, a propyl group, a butyl group, an isopropyl group, an isobutyl group, or a tert-butyl group, and an alkenyl group having 1 to 10 carbon atoms such as a vinyl group, an allyl group or a butenyl group, among which a hydrogen atom or a methyl group is preferred. Examples of this type of epoxy resin include epoxy resins comprising the diglycidyl ether of 4,4′-methylenebis(2,6-dimethylphenol) as the principal component; epoxy resins comprising the diglycidyl ether of 4,4′-methylenebis (2,3,6-trimethylphenol) as the principal component; and epoxy resins comprising the diglycidyl ether of 4,4′-methylenebisphenol as the principal component, among which epoxy resins comprising the diglycidyl ether of 4,4′-methylenebis(2,6-dimethylphenol) as the principal component are particularly preferred. This type of epoxy resin is available as a commercial product under the trade name YSLV-80XY manufactured by Nippon Steel Chemical Group. The amount of the bisphenol F type epoxy resin incorporated is preferably 20% by mass or more, more preferably 30% by mass or more, even more preferably 50% by mass or more, based on the total amount of the epoxy resins, in order to exhibit its performance.

Examples of the novolac type epoxy resins include epoxy resins represented by the general formula (VIII):

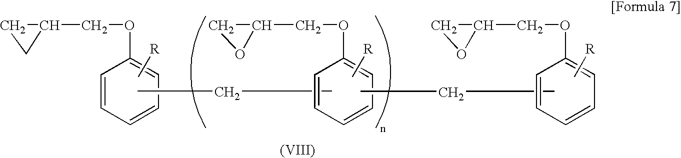

wherein R is selected from a hydrogen atom and substituted or unsubstituted monovalent hydrocarbon groups having 1 to 10 carbon atoms, and n is either 0 or an integer of 0 to 10.

The novolac type epoxy resins represented by the general formula (VIII) are easily obtained by reacting epichlorohydrin with a novolac type phenol resin. Examples of R in the general formula (VIII) include an alkyl group having 1 to 10 carbon atoms such as a methyl group, an ethyl group, a propyl group, a butyl group, an isopropyl group or an isobutyl group, and an alkoxyl group having 1 to 10 carbon atoms such as a methoxy group, an ethoxy group, a propoxy group or a butoxy group, among which a hydrogen atom or a methyl group is preferred. n is preferably an integer of 0 to 3. Among the novolac type epoxy resins represented by the general formula (VIII), ortho-cresol novolac type epoxy resins are preferable. When the novolac type epoxy resin is used, the amount of the resin incorporated is preferably 20% by mass or more, more preferably 30% by mass or more, based on the total amount of the epoxy resins, in order to exhibit its performance.

Examples of the dicyclopentadiene type epoxy resins include epoxy resins represented by the general formula (IX):

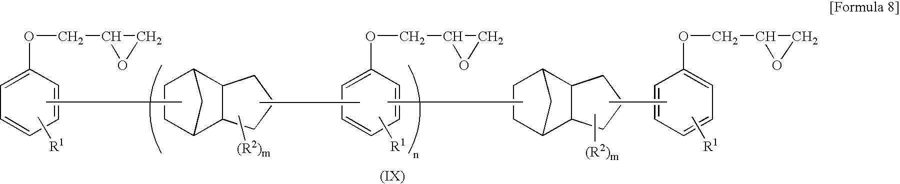

wherein R¹ and R² are independently selected from a hydrogen atom and substituted or unsubstituted monovalent hydrocarbon groups having 1 to 10 carbon atoms; n is an integer of 0 to 10; and m is an integer of 0 to 6.

Examples of R¹ in the general formula (IX) include a hydrogen atom and a substituted or unsubstituted monovalent hydrocarbon group having 1 to 10 carbon atoms, for example an alkyl group such as a methyl group, an ethyl group, a propyl group, a butyl group, an isopropyl group or a tert-butyl group, an alkenyl group such as a vinyl group, an allyl group or a butenyl group, a halogenated alkyl group, an amino group-substituted alkyl group or a mercapto group-substituted alkyl group, among which an alkyl group such as a methyl group or an ethyl group and a hydrogen atom are preferable, and a methyl group and a hydrogen atom are more preferable. Examples of R² include a hydrogen atom and a substituted or unsubstituted monovalent hydrocarbon group having 1 to 10 carbon atoms, for example an alkyl group such as a methyl group, an ethyl group, a propyl group, a butyl group, an isopropyl group or a tert-butyl group, an alkenyl group such as a vinyl group, an allyl group or a butenyl group, a halogenated alkyl group, an amino group-substituted alkyl group or a mercapto group-substituted alkyl group, among which a hydrogen atom is preferable. When the dicyclopentadiene type epoxy resin is used, the amount of the resin incorporated is preferably 20% by mass or more, more preferably 30% by mass or more, based on the total amount of the epoxy resins, in order to exhibit its performance.

Examples of the naphthalene type epoxy resins include epoxy resins represented by the general formula (X) below, and examples of the triphenylmethane type epoxy resins include epoxy resins represented by the general formula (XI) below.

The naphthalene type epoxy resins represented by the general formula (X) include random copolymers wherein constituent units, the number of which is m, and constituent units, the number of which is n, are contained at random, alternate copolymers containing the constituent units alternately, copolymers containing the constituent units regularly, and block copolymers containing the constituent units in a block form. These copolymers may be used alone or in combination of two or more thereof.

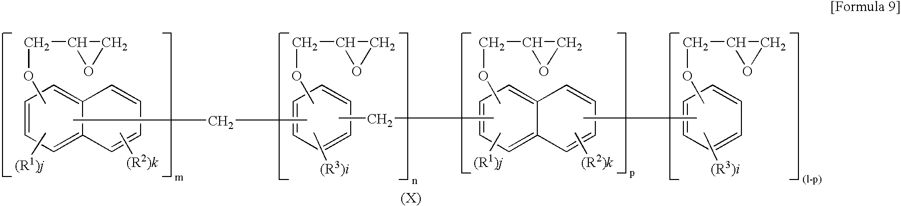

wherein R¹ to R³ are selected from a hydrogen atom and substituted or unsubstituted monovalent hydrocarbon groups having 1 to 12 carbon atoms, and may be the same as or different from one another; p represents 1 or 0, and m and n each represent an integer of 0 to 11 and are selected such that (m+n) is an integer of 1 to 11, and simultaneously, (m+p) is an integer of 1 to 12; i represents an integer of 0 to 3; j represents an integer of 0 to 2; and k represents an integer of 0 to 4.

The triphenylmethane type epoxy resins represented by the general formula (XI) are not particularly limited, but are preferably salicylaldehyde type epoxy resins.

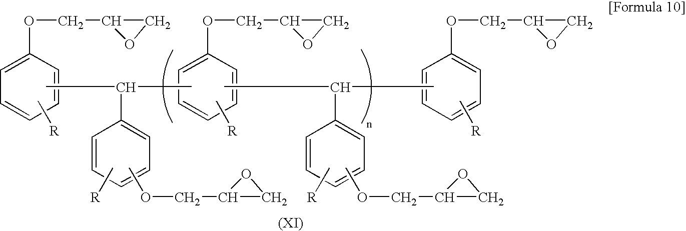

wherein R is selected from a hydrogen atom and substituted or unsubstituted monovalent hydrocarbon groups having 1 to 10 carbon atoms, and n is an integer of 1 to 10.

The naphthalene type epoxy resin and the triphenylmethane type epoxy resin may be used singly or may be used simultaneously, and the amount of the 2 resins incorporated is preferably 20% by mass or more, more preferably 30% by mass or more, even more preferably 50% by mass or more, based on the total amount of the epoxy resins, in order to exhibit their performance.

Examples of the epoxidation products of phenol-aralkyl resins include epoxy resins represented by the following general formula (XII):

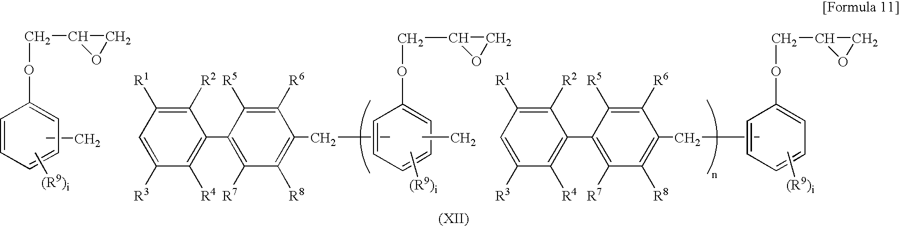

wherein R¹ to R⁹ are selected from a hydrogen atom and substituted or unsubstituted monovalent hydrocarbon groups having 1 to 12 carbon atoms, and may be the same as or different from one another; i is either 0 or an integer of 1 to 3; and n is either 0 or an integer of 1 to 10.

The epoxidation products of biphenylene skeleton-containing phenol-aralkyl resins represented by the general formula (XII) are obtained in a known method by reacting epichlorohydrin with a phenol-aralkyl resin synthesized from an alkyl-substituted, aromatic ring-substituted, or unsubstituted phenol and bis(methoxymethyl)biphenyl. Examples of R¹ to R⁹ in the general formula (XII) include a linear alkyl group such as a methyl group, an ethyl group, a propyl group, an isopropyl group, an n-butyl group, a sec-butyl group, a tert-butyl group, a pentyl group, a hexyl group, an octyl group, a decyl group or a dodecyl group; a cyclic alkyl group such as a cyclopentyl group, a cyclohexyl group, a cycloheptyl group, a cyclopentenyl group or a cyclohexenyl group; an aryl group-substituted alkyl group such as a benzyl group or a phenethyl group; an alkoxy group-substituted alkyl group such as a methoxy group-substituted alkyl group, an ethoxy group-substituted alkyl group or a butoxy group-substituted alkyl group; an amino group-substituted alkyl group such as an aminoalkyl group, a dimethylaminoalkyl group or a diethylaminoalkyl group; a hydroxyl group-substituted alkyl group; an unsubstituted aryl group such as a phenyl group, a naphthyl group or a biphenyl group; an alkyl group-substituted aryl group such as a tolyl group, a dimethylphenyl group, an ethylphenyl group, a butylphenyl group, a tert-butylphenyl group or a dimethylnaphthyl group; an alkoxy group-substituted aryl group such as a methoxyphenyl group, an ethoxyphenyl group, a butoxyphenyl group, a tert-butoxyphenyl group or a methoxynaphthyl group; an amino group-substituted aryl group such as a dimethylamino group or a diethylamino group; and a hydroxyl group-substituted aryl group, among which a hydrogen atom or a methyl group is preferable. In the general formula (XII), n is preferably 6 or less on average, and such an epoxy resin is commercially available under the trade name NC-3000S manufactured by Nippon Kayaku Co., Ltd.

From the viewpoint of achieving flame retardancy, reflow resistance and fluidity simultaneously, the resin preferably contains an epoxy resin represented by the general formula (V), particularly a resin of the general formula (XII) wherein R¹ to R⁸ each represent a hydrogen atom and a resin of the general formula (V) wherein R¹ to R⁸ each represent a hydrogen atom and n=0. The compounding mass ratio of (V)/(XII) is preferably 50/50 to 5/95, more preferably 40/60 to 10/90, still more preferably 30/70 to 15/85. CER-3000L (trade name, manufactured by Nippon Kayaku Co., Ltd.) or the like is available as a commercial product satisfying such compounding mass ratio.

Examples of the epoxidation products of naphthol-aralkyl resins include epoxy resins represented by the general formula (XIII):

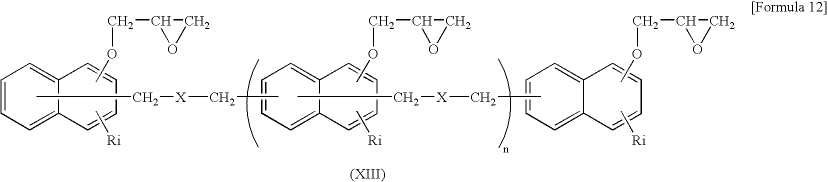

wherein R is selected from a hydrogen atom and substituted or unsubstituted monovalent hydrocarbon groups having 1 to 12 carbon atoms, and may be the same as or different from one another; i is either 0 or an integer of 1 to 3; X represents a divalent organic group containing an aromatic ring; and n is either 0 or an integer of 1 to 10.

Examples of X include an arylene group such as a phenylene group, a biphenylene group or a naphthylene group, an alkyl group-substituted arylene group such as a tolylene group, an alkoxy group-substituted arylene group, an aralkyl group-substituted arylene group, a divalent group obtained from an aralkyl group such as a benzyl group or a phenethyl group, and a divalent group containing an arylene group such as a xylylene group. From the viewpoint of achieving both flame retardancy and storage stability, X is preferably a phenylene group or a biphenylene group.

The epoxidation products of naphthol-aralkyl resins represented by the general formula (XIII) is obtained in a known method by reacting epichlorohydrin with a naphthol-aralkyl resin synthesized from an alkyl-substituted, aromatic ring-substituted, or unsubstituted naphthol and dimethoxyparaxylene or bis(methoxymethyl)biphenyl. Examples of R in the general formula (XIII) include a linear alkyl group such as a methyl group, an ethyl group, a propyl group, an isopropyl group, an n-butyl group, a sec-butyl group, a tert-butyl group, a pentyl group, a hexyl group, an octyl group, a decyl group or a dodecyl group; a cyclic alkyl group such as a cyclopentyl group, a cyclohexyl group, a cycloheptyl group, a cyclopentenyl group or a cyclohexenyl group; an aryl group-substituted alkyl group such as a benzyl group or a phenethyl group; an alkoxy group-substituted alkyl group such as a methoxy group-substituted alkyl group, an ethoxy group-substituted alkyl group or a butoxy group-substituted alkyl group; an amino group-substituted alkyl group such as an aminoalkyl group, a dimethylaminoalkyl group or a diethylaminoalkyl group; a hydroxyl group-substituted alkyl group; an unsubstituted aryl group such as a phenyl group, a naphthyl group or a biphenyl group; an alkyl group-substituted aryl group such as a tolyl group, a dimethylphenyl group, an ethylphenyl group, a butylphenyl group, a tert-butylphenyl group or a dimethylnaphthyl group; an alkoxy group-substituted aryl group such as a methoxyphenyl group, an ethoxyphenyl group, a butoxyphenyl group, a tert-butoxyphenyl group or a methoxynaphthyl group; an amino group-substituted aryl group such as a dimethylamino group or a diethylamino group; and a hydroxyl group-substituted aryl group, among which a hydrogen atom or a methyl group is preferable, and such an epoxy resin includes epoxidation products of naphthol-aralkyl resins represented by the general formula (XIV) or (XV) below. n is either 0 or an integer of 1 to 10, more preferably 6 or less on average.

Commercial products of the epoxy resins represented by the general formula (XIV) include a product under the trade name ESN-375 manufactured by Nippon Steel Chemical Group. Commercial products of the epoxy resins represented by the general formula (XV) include a product under the trade name ESN-175 manufactured by Nippon Steel Chemical Group. The amount of the epoxidation products of naphthol-aralkyl resins incorporated is preferably 20% by mass or more, more preferably 30% by mass or more, even more preferably 50% by mass or more, based on the total amount of the epoxy resins, in order to exhibit their performance.

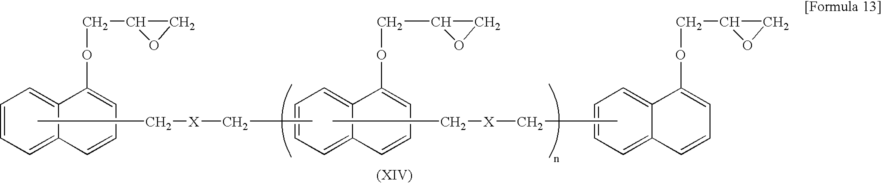

wherein X represents a divalent organic group containing an aromatic ring, and n represents either 0 or an integer of 1 to 10.

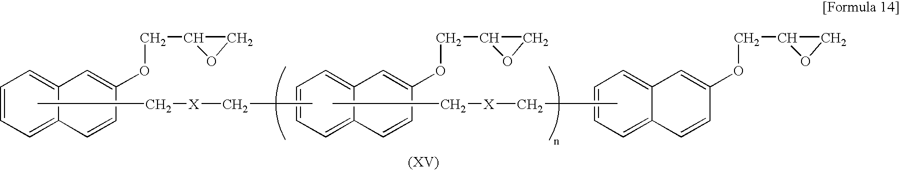

wherein X represents a divalent organic group containing an aromatic ring, and n represents either 0 or an integer of 1 to 10.

The biphenyl type epoxy resins, thiodiphenol type epoxy resins, bisphenol F type epoxy resins, novolac type epoxy resins, dicyclopentadiene type epoxy resins, naphthalene type epoxy resins, triphenylmethane type epoxy resins, epoxidation products of phenol-aralkyl resins, and epoxidation products of naphthol-aralkyl resins may be used singly or in combination of two or more thereof. When two or more of these materials are used, the total amount of the materials incorporated is preferably 50% by mass or more, more preferably 60% by mass or more, even more preferably 80% by mass or more, based on the total amount of the epoxy resins.

The curing agent (B) used in the present invention is not particularly limited as long as it is generally used in epoxy resin molding materials for sealing, and examples thereof include novolac type phenol resins prepared by condensation or co-condensation of phenols such as phenol cresol, resorcin, catechol, bisphenol A, bisphenol F, phenylphenol, thiodiphenol or aminophenol and/or naphthols such as α-naphthol, β-naphthol or dihydroxynaphthalene, with an aldehyde group-containing compound such as formaldehyde, benzaldehyde or salicylaldehyde, in the presence of an acid catalyst; aralkyl type phenol resins such as phenol-aralkyl resins and naphthol-aralkyl resins synthesized from phenols and/or naphthols and dimethoxyparaxylene or bis(methoxymethyl)biphenyl; copolymer type phenol-aralkyl resins wherein a phenol-novolac structure and a phenol-aralkyl structure are repeated at random, in a block form or alternately; paraxylylene and/or metaxylylene modification phenol resins; melamine modification phenol resins; terpene modification phenol resins; dicyclopentadiene modification phenol resins; cyclopentadiene modification phenol resins; and polycyclic aromatic ring modification phenol resins, and these resins may be used alone or in combination of two or more thereof.

Among them, the phenol-aralkyl resins, the copolymer type phenol-aralkyl resins and the naphthol-aralkyl resins are preferable from the viewpoint of fluidity, flame retardancy and reflow resistance, the triphenylmethane type phenol resins are preferable from the viewpoint of heat resistance, low expansion coefficient and low warpage, and the novolac type phenol resins are preferable from the viewpoint of curability. At least one member of these phenol resins is preferably contained.

Examples of the phenol-aralkyl resins include resins represented by the following general formula (XVI):

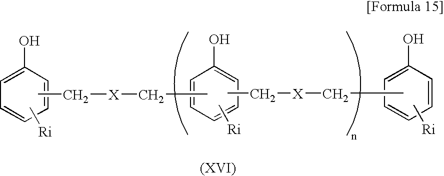

wherein R's are selected from a hydrogen atom and substituted or unsubstituted monovalent hydrocarbon groups having 1 to 12 carbon atoms, and may be the same as or different from one another; i is either 0 or an integer of 1 to 3; X represents a divalent organic group containing an aromatic ring; and n is either 0 or an integer of 1 to 10.

Examples of R in the general formula (XVI) include a linear alkyl group such as a methyl group, an ethyl group, a propyl group, an isopropyl group, an n-butyl group, a sec-butyl group, a tert-butyl group, a pentyl group, a hexyl group, an octyl group, a decyl group or a dodecyl group; a cyclic alkyl group such as a cyclopentyl group, a cyclohexyl group, a cycloheptyl group, a cyclopentenyl group or a cyclohexenyl group; an aryl group-substituted alkyl group such as a benzyl group or a phenethyl group; an alkoxy group-substituted alkyl group such as a methoxy group-substituted alkyl group, an ethoxy group-substituted alkyl group or a butoxy group-substituted alkyl group; an amino group-substituted alkyl group such as an aminoalkyl group, a dimethylaminoalkyl group or a diethylaminoalkyl group; a hydroxyl group-substituted alkyl group; an unsubstituted aryl group such as a phenyl group, a naphthyl group or a biphenyl group; an alkyl group-substituted aryl group such as a tolyl group, a dimethylphenyl group, an ethylphenyl group, a butylphenyl group, a tert-butylphenyl group or a dimethylnaphthyl group; an alkoxy group-substituted aryl group such as a methoxyphenyl group, an ethoxyphenyl group, a butoxyphenyl group, a tert-butoxyphenyl group or a methoxynaphthyl group; an amino group-substituted aryl group such as a dimethylamino group or a diethylamino group; and a hydroxyl group-substituted aryl group, among which a hydrogen atom or a methyl group is preferable.

X represents a group containing an aromatic ring, and examples thereof include an arylene group such as a phenylene group, a biphenylene group or a naphthylene group, an alkyl group-substituted arylene group such as a tolylene group, an alkoxyl group-substituted arylene group, a divalent group obtained from an aralkyl group such as a benzyl group or a phenethyl group, an aralkyl group-substituted arylene group, and a divalent group containing an arylene group such as a xylylene group. From the viewpoint of achieving flame retardancy, fluidity and curability simultaneously, X is preferably a substituted or unsubstituted phenylene group, and examples of such resins include phenol-aralkyl resins represented by the general formula (XVII) below, and from the viewpoint of achieving both flame retardancy and reflow resistance, X is preferably a substituted or unsubstituted biphenylene group, and examples of such resins include phenol-aralkyl resins represented by the general formula (XVIII) below. n represents either 0 or an integer of 1 to 10, more preferably 6 or less on average.

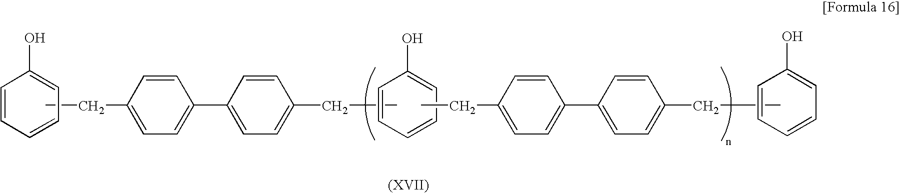

wherein n represents either 0 or an integer of 1 to 10.

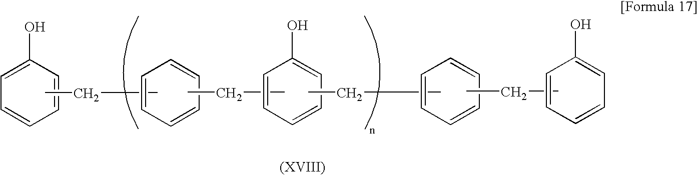

wherein n represents either 0 or an integer of 1 to 10.

The biphenylene skeleton-containing phenol-aralkyl resins represented by the general formula (XVII) include a commercial product under the trade name MEH-7851 manufactured by Meiwa Plastic Industries, Ltd. The phenol-aralkyl resins represented by the general formula (XVIII) include a product under the trade name XLC manufactured by Mitsui Chemicals, Inc. The amount of the phenol-aralkyl resin incorporated is preferably 20% by mass or more, more preferably 30% by mass or more, even more preferably 50% by mass or more, based on the total amount of the curing agent, in order to exhibit its performance.

Examples of the naphthol-aralkyl resins include resins represented by the following general formula (XIX):

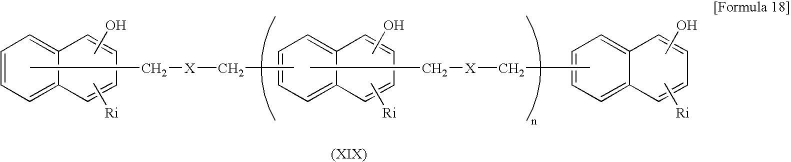

wherein R's are selected from a hydrogen atom and substituted or unsubstituted monovalent hydrocarbon groups having 1 to 12 carbon atoms, and may be the same as or different from one another; i is either 0 or an integer of 1 to 3; X represents a divalent organic group containing an aromatic ring; and n is either 0 or an integer of 1 to 10.

Examples of R in the general formula (XIX) include a linear alkyl group such as a methyl group, an ethyl group, a propyl group, an isopropyl group, an n-butyl group, a sec-butyl group, a tert-butyl group, a pentyl group, a hexyl group, an octyl group, a decyl group or a dodecyl group; a cyclic alkyl group such as a cyclopentyl group, a cyclohexyl group, a cycloheptyl group, a cyclopentenyl group or a cyclohexenyl group; an aryl group-substituted alkyl group such as a benzyl group or a phenethyl group; an alkoxy group-substituted alkyl group such as a methoxy group-substituted alkyl group, an ethoxy group-substituted alkyl group or a butoxy group-substituted alkyl group; an amino group-substituted alkyl group such as an aminoalkyl group, a dimethylaminoalkyl group or a diethylaminoalkyl group; a hydroxyl group-substituted alkyl group; an unsubstituted aryl group such as a phenyl group, a naphthyl group or a biphenyl group; an alkyl group-substituted aryl group such as a tolyl group, a dimethylphenyl group, an ethylphenyl group, a butylphenyl group, a tert-butylphenyl group or a dimethylnaphthyl group; an alkoxy group-substituted aryl group such as a methoxyphenyl group, an ethoxyphenyl group, a butoxyphenyl group, a tert-butoxyphenyl group or a methoxynaphthyl group; an amino group-substituted aryl group such as a dimethylamino group or a diethylamino group; and a hydroxyl group-substituted aryl group, among which a hydrogen atom or a methyl group is preferable.

X represents a divalent organic group containing an aromatic ring, and examples thereof include an arylene group such as a phenylene group, a biphenylene group or a naphthylene group, an alkyl group-substituted arylene group such as a tolylene group, an alkoxyl group-substituted arylene group, an aralkyl group-substituted arylene group, a divalent group obtained from an aralkyl group such as a benzyl group or a phenethyl group, and a divalent group containing an arylene group such as a xylylene group. From the viewpoint of storage stability and flame retardancy, X is preferably a substituted or unsubstituted phenylene or biphenylene group, more preferably a phenylene group, and examples of such resins include naphthol-aralkyl resins represented by the following general formulae (XX) and (XXI). n represents either 0 or an integer of 1 to 10, more preferably 6 or less on average.

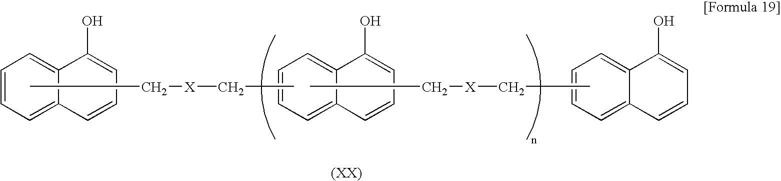

wherein X represents a divalent organic group containing an aromatic ring, and n represents either 0 or an integer of 1 to 10.

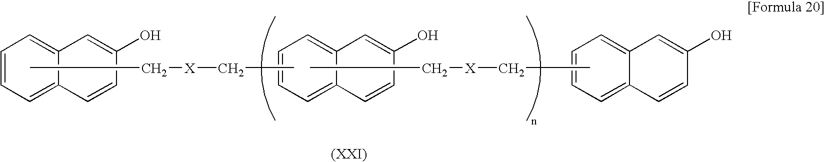

wherein X represents a divalent organic group containing an aromatic ring, and n represents either 0 or an integer of 1 to 10.

The naphthol-aralkyl resins represented by the general formula (XX) include a commercial product under the trade name SN-475 manufactured by Nippon Steel Chemical Group. The naphthol-aralkyl resins represented by the general formula (XXI) include a commercial product under the trade name SN-170 manufactured by Nippon Steel Chemical Group. The amount of the naphthol-aralkyl resin incorporated is preferably 20% by mass or more, more preferably 30% by mass or more, even more preferably 50% by mass or more, based on the total amount of the curing agent, in order to exhibit its performance.

From the viewpoint of flame retardancy, a part or the whole of the phenol-aralkyl resins represented by the general formula (XVI) and the naphthol-aralkyl resins represented by the general formula (XIX) are preferably premixed with acenaphthylene. Acenaphthylene can be obtained by dehydrogenation of acenaphthene, but a commercial product may also be used. Alternatively, a polymer of acenaphthylene, or a polymer of acenaphthylene and another aromatic olefin, may be used instead of acenaphthylene. Examples of suitable methods of obtaining a polymer of acenaphthylene, or a polymer of acenaphthylene and another aromatic olefin, include radical polymerization, cationic polymerization, and anionic polymerization. During this polymerization, a conventionally known catalyst can be used, but polymerization may also be conducted by heating only without using a catalyst. In this case, the polymerization temperature is preferably in the range of 80 to 160° C., more preferably 90 to 150° C. The softening point of the polymer of acenaphthylene or the polymer of acenaphthylene and another aromatic olefin thus obtained is preferably in the range of 60 to 150° C., more preferably 70 to 130° C.

If this softening point is lower than 60° C., then the moldability tends to deteriorate due to exudation during molding, whereas if the softening point is higher than 150° C., the compatibility with the resin tends to deteriorate. Examples of another aromatic olefin to be copolymerized with acenaphthylene include styrene, α-methylstyrene, indene, benzothiophene, benzofuran, vinylnaphthalene, vinylbiphenyl, and alkyl-substituted derivatives of these olefins. Besides the aromatic olefin described above, aliphatic olefins may also be used in combination, provided that the effects of the present invention are not impaired. Examples of suitable aliphatic olefins include (meth)acrylic acid and esters thereof, as well as maleic anhydride, itaconic anhydride, fumaric acid, and esters thereof. The amount of these aliphatic olefins used is preferably 20% by mass or less, more preferably 9% by mass or less, based on the total amount of the polymerization monomers.

Examples of suitable methods of premixing either a part or the whole of the curing agent with acenaphthylene include a method in which the curing agent and the acenaphthylene are both ground finely, and then mixed together in a solid state using a mixer or the like; a method in which both components are dissolved uniformly in a suitable solvent, and the solvent is then removed; and a method in which the two components are subjected to melt mixing at a temperature at least as high as the softening point of the curing agent and/or the acenaphthylene. Of these methods, the melt mixing method which enables a uniform mixture to be obtained with minimal impurity contamination is preferred. By the method described above, a preliminary mixture (an acenaphthylene-modified curing agent) is produced. There are no particular restrictions on the melt mixing temperature, provided it is at least as high as the softening point of the curing agent and/or the acenaphthylene, but temperatures in the range of 100 to 250° C. are preferred, and temperatures from 120 to 200° C. are even more desirable. There are no particular restrictions on the melt mixing time, provided the two components are mixed uniformly, but a time in the range of 1 to 20 hours is preferred, and times from 2 to 15 hours are even more desirable. In those cases where the curing agent and the acenaphthylene are premixed, no problems arise if the acenaphthylene undergoes either polymerization or reaction with the curing agent within the mixture.

Examples of the triphenylmethane type phenol resins include phenol resins represented by the following general formula (XXII):

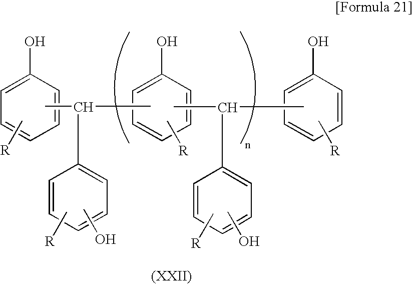

wherein R is selected from a hydrogen atom and substituted or unsubstituted monovalent hydrocarbon groups having 1 to 10 carbon atoms, and n is an integer of 0 to 10.

Examples of R in the general formula (XXII) include a hydrogen atom and a substituted or unsubstituted monovalent hydrocarbon group having 1 to 10 carbon atoms, for example an alkyl group such as a methyl group, an ethyl group, a propyl group, a butyl group, an isopropyl group or a tert-butyl group, an alkenyl group such as a vinyl group, an allyl group or a butenyl group, a halogenated alkyl group, an amino group-substituted alkyl group or a mercapto group-substituted alkyl group, among which an alkyl group such as a methyl group or an ethyl group and a hydrogen atom are preferable, and a methyl group and a hydrogen atom are more preferable. When the triphenylmethane type phenol resin is used, the amount of this resin incorporated is preferably 30% by mass or more, more preferably 50% by mass or more, based on the total amount of the curing agent, in order to exhibit its performance.

Examples of the novolac type phenol resins include novolac type phenol resins such as phenol resins represented by the general formula (XXIII) below and cresol novolac resins, and particularly the novolac type phenol resins represented by the general formula (XXIII) are preferable.

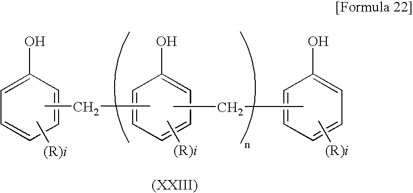

wherein R is selected from a hydrogen atom and substituted or unsubstituted monovalent hydrocarbon groups having 1 to 10 carbon atoms; i is an integer of 0 to 3; and n is an integer of 0 to 10.

Examples of R in the general formula (XXIII) include a hydrogen atom and a substituted or unsubstituted monovalent hydrocarbon group having 1 to 10 carbon atoms, for example an alkyl group such as a methyl group, an ethyl group, a propyl group, a butyl group, an isopropyl group or a tert-butyl group, an alkenyl group such as a vinyl group, an allyl group or a butenyl group, a halogenated alkyl group, an amino group-substituted alkyl group or a mercapto group-substituted alkyl group, among which an alkyl group such as a methyl group or an ethyl group and a hydrogen atom are preferable, and a hydrogen atom is more preferable, and n is preferably 0 to 8 on average. When the novolac type phenol resin is used, the amount of this resin incorporated is preferably 30% by mass or more, more preferably 50% by mass or more, based on the total amount of the curing agent, in order to exhibit its performance.

Examples of the copolymer type phenol-aralkyl resin include phenol resins represented by the following general formula (XXIV):

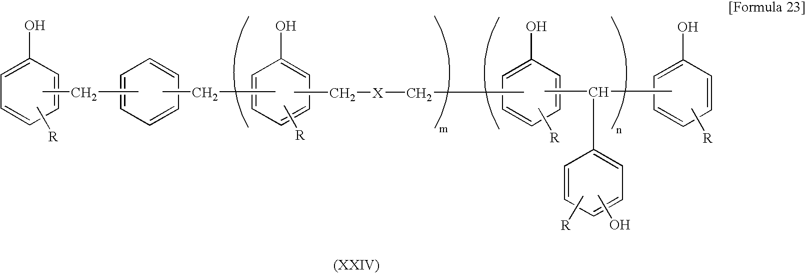

wherein R's are selected from a hydrogen atom, a substituted or unsubstituted monovalent hydrocarbon group having 1 to 12 carbon atoms, and a hydroxyl group, and may be the same as or different from one another; X represents a divalent group containing an aromatic ring; and n and m each represent either 0 or an integer of 1 to 10.

Examples of R in the general formula (XXIV) include a linear alkyl group such as a methyl group, an ethyl group, a propyl group, an isopropyl group, an n-butyl group, a sec-butyl group, a tert-butyl group, a pentyl group, a hexyl group, an octyl group, a decyl group or a dodecyl group; a cyclic alkyl group such as a cyclopentyl group, a cyclohexyl group, a cycloheptyl group, a cyclopentenyl group or a cyclohexenyl group; an aryl group-substituted alkyl group such as a benzyl group or a phenethyl group; an alkoxy group-substituted alkyl group such as a methoxy group-substituted alkyl group, an ethoxy group-substituted alkyl group or a butoxy group-substituted alkyl group; an amino group-substituted alkyl group such as an aminoalkyl group, a dimethylaminoalkyl group or a diethylaminoalkyl group; a hydroxyl group-substituted alkyl group; an unsubstituted aryl group such as a phenyl group, a naphthyl group or a biphenyl group; an alkyl group-substituted aryl group such as a tolyl group, a dimethylphenyl group, an ethylphenyl group, a butylphenyl group, a tert-butylphenyl group or a dimethylnaphthyl group; an alkoxy group-substituted aryl group such as a methoxyphenyl group, an ethoxyphenyl group, a butoxyphenyl group, a tert-butoxyphenyl group or a methoxynaphthyl group; an amino group-substituted aryl group such as a dimethylamino group or a diethylamino group; and a hydroxyl group-substituted aryl group, among which a hydrogen atom or a methyl group is preferable. Each of n and m is either 0 or an integer of 1 to 10, more preferably 6 or less on average.

Examples of X in the general formula (XXIV) include an arylene group such as a phenylene group, a biphenylene group or a naphthylene group, an alkyl group-substituted arylene group such as a tolylene group, an alkoxy group-substituted arylene group, an aralkyl group-substituted arylene group, a divalent group obtained from an aralkyl group such as a benzyl group or a phenethyl group, and a divalent group containing an arylene group such as a xylylene group. From the viewpoint of achieving both storage stability and flame retardancy, X is preferably a substituted or unsubstituted phenylene or biphenylene group.

The compound represented by the general formula (XXIV) is commercially available for example under the trade name HE-510 (manufactured by Sumikin Air Water Chemical Inc.).

When the copolymer type phenol-aralkyl resin is used, the amount of this resin incorporated is preferably 30% by mass or more, more preferably 50% by mass or more, based on the total amount of the curing agent, in order to exhibit its performance.

The phenol-aralkyl resins, naphthol-aralkyl resins, dicyclopentadiene type phenol resins, triphenylmethane type phenol resins, novolac type phenol resins and copolymer type phenol-aralkyl resins may be used alone or in combination of two or more thereof. When two or more of these resins are used in combination, their total amount is preferably 50% by mass or more, more preferably 60% by mass or more, even more preferably 80% by mass or more, based on the total amount of the phenol resins.

In the present invention, the equivalent ratio of the curing agent (B) to the epoxy resin (A), i.e., the ratio of the number of hydroxyl groups in the curing agent to the number of epoxy groups in the epoxy resin (number of hydroxyl groups in the curing agent/number of epoxy groups in the epoxy resin) is not particularly limited, but is preferably established in the range of 0.5 to 2, more preferably 0.6 to 1.3, in order to reduce the amount of the respective unreacted groups. The equivalent ratio is established more preferably in the range of 0.8 to 1.2, in order to obtain am epoxy-resin molding material for sealing excellent in moldability and reflow soldering resistance.

The acrylic compound (C) used in the present invention is not particularly limited insofar as it is a compound obtained by polymerizing polymerizable unsaturated compounds represented by the general formula (I) and (II) below wherein the mass ratio of (I) to (II) ((I)/(II)) is 0 to 10.

When the acrylic compound (C) is a copolymer, the copolymer includes a random copolymer comprising structural units obtained from compounds represented respectively by the formulae (I) and (II) below at random, an alternating copolymer comprising the same alternately, a copolymer comprising the same regularly, and a block copolymer comprising the same in a block form. These may be used alone or in combination of two or more thereof.

The terminal structure of the acrylic compound may be modified with a conventionally known chain transfer agent such as a hydrogen atom- and mercapto group-containing compound.

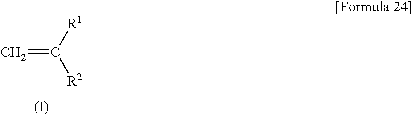

wherein R¹ represents a hydrogen atom or a methyl group, and R² represents a silicon atom-free monovalent organic group.

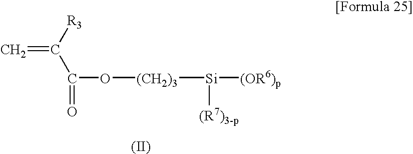

wherein R³ represents a hydrogen atom or a methyl group, R⁶ represents a hydrogen atom or a hydrocarbon group having 1 to 6 carbon atoms, R⁷ represents a hydrocarbon group having 1 to 6 carbon atoms, and p is an integer of 1 to 3.

In the general formula (I), R² is preferably a group represented by the general formula (III) below, a —CO—NH₂ group, a —CN group, an alkyl group, an alkenyl group, a cycloalkenyl group, an aryl group, an aldehyde group, a hydroxyalkyl group, a carboxyalkyl group, a hydrocarbon group having 1 to 6 carbon atoms which is bound via an amide structure, a monovalent heterocyclic group, an organic group bound via a divalent or trivalent heteroatom, and a group having a hydrocarbon group bound via a divalent or trivalent heteroatom to an organic group. These groups may be substituted.

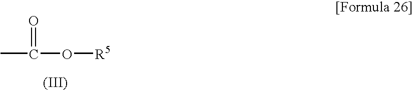

wherein R⁵ represents a hydrogen atom, an alkali metal atom or a substituted or unsubstituted organic group having 1 to 22 carbon atoms.

In the general formula (III), R⁵ is preferably a hydrocarbon group wherein at least a part of hydrogen atoms may be substituted by a chlorine atom, a fluorine atom, an amino group, an amine salt, an amido group, an isocyanato group, an alkyloxide group, a glycidyl group, an aziridine group, a hydroxyl group, an alkoxy group, an acetoxy group or an acetacetoxy group.

The “hydrocarbon group having 1 to 6 carbon atoms which is bound via an amide structure” represented by R² is a group represented by —CO—NH—R or —CO—N═R wherein R is the hydrocarbon group defined above and may be monovalent or divalent and may be substituted.

Specific examples of the compounds represented by the general formula (I) include:

acrylic acid and salts such as alkali metal acrylates, methacrylic acid and salts such as alkali metal methacrylates,

alkylacrylates such as methylacrylate, ethyl acrylate, propyl acrylate, n-butyl acrylate, tert-butyl acrylate, pentyl acrylate, hexyl acrylate, 2-ethylhexyl acrylate, octyl acrylate, nonyl acrylate, decyl acrylate and dodecyl acrylate, aryl acrylates such as phenyl acrylate and benzyl acrylate, alkoxyalkyl acrylates such as methoxyethyl acrylate, ethoxyethyl acrylate, propoxyethyl acrylate, butoxyethyl acrylate and ethoxypropyl acrylate,

alkyl methacrylates such as methyl methacrylate, ethyl methacrylate, propyl methacrylate, n-butyl methacrylate, tert-butyl methacrylate, pentyl methacrylate, hexyl methacrylate, 2-ethylhexyl methacrylate, octyl methacrylate, nonyl methacrylate, decyl methacrylate and dodecyl methacrylate, lauryl methacrylate and stearyl methacrylate, aryl methacrylates such as phenyl methacrylate and benzyl methacrylate, alkoxyalkyl methacrylates such as methoxyethyl methacrylate, ethoxyethyl methacrylate, propoxyethyl methacrylate, butoxyethyl methacrylate and ethoxypropyl methacrylate, and

ester compounds having an acetoacetoxy structure, such as acetoacetoxyethyl acrylate and acetoacetoxyethyl methacrylate.

Esters of substituted or unsubstituted divalent or more alcohols and acrylic acid or methacrylic acid include (poly)alkylene glycol diacrylates such as ethylene glycol diacrylate, diethylene glycol diacrylate, triethylene glycol diacrylate, polyethylene glycol diacrylate, propylene glycol diacrylate, dipropylene glycol diacrylate and tripropylene glycol diacrylate, (poly)alkylene glycol dimethacrylates such as ethylene glycol dimethacrylate, diethylene glycol dimethacrylate, triethylene glycol dimethacrylate, polyethylene glycol diacrylate, propylene glycol dimethacrylate, dipropylene glycol dimethacrylate and tripropylene glycol dimethacrylate, and

polyvalent acrylates such as trimethylol propane triacrylate and polyvalent methacrylates such as trimethylol propane trimethacrylate.

Further examples include nitrile group-containing compounds such as acrylonitrile and methacrylonitrile, vinyl ester compounds such as vinyl acetate and vinyl benzoate, alkyl group-substituted vinyl compounds such as 1-propene, 1-butene, 1-pentene, 1-hexene, 1-heptene, 1-octene, 1-nonene, 1-decene, 1-undecene and 1-dodecene, aryl group-substituted vinyl compounds such as styrene and vinyl toluene, ester compounds of alicyclic alcohols, such as cyclohexyl acrylate and cyclohexyl methacrylate,

oxazoline group-containing polymerizable compounds such as 2-vinyl-2-oxazoline, 2-vinyl-5-methyl-2-oxazoline and 2-isopropenyl-2-oxazoline, aziridine group-containing polymerizable compounds such as acryloyl aziridine, methacryloyl aziridine, 2-aziridinylethyl acrylate and 2-aziridinylethyl methacrylate, glycidyl group-containing vinyl compounds such as allyl glycidyl ether, acrylic acid glycidyl ether, methacrylic acid glycidyl ether, acrylic acid-2-ethyl glycidyl ether and methacrylic acid-2-ethyl glycidyl ether,

hydroxyl group-containing vinyl compounds such as 2-hydroxyethyl acrylate, 2-hydroxyethyl methacrylate, 2-hydroxypropyl acrylate, a monoester between acrylic acid or methacrylic acid and polypropylene glycol or polyethylene glycol, and a ring opening addition polymerization adduct between lactone and 2-hydroxyethyl acrylate or 2-hydroxyethyl methacrylate, fluorine-containing vinyl compounds such as fluorine-substituted alkyl methacrylate and fluorine-substituted alkyl acrylates, halogenated vinyl compounds such as 2-chloroethyl acrylate and 2-chloroethyl methacrylate, reactive halogen-containing vinyl compounds such as 2-chloroethyl vinyl ether and vinyl monochloroacetate, unsaturated carboxylic acids meeting the structure of the formula (I) excluding methacrylic acid and acrylic acid, salts of the unsaturated carboxylic acids, ester compounds thereof, derivatives thereof such as acid anhydrides, amide structure-containing vinyl compounds such as methacrylamide, N-methylol methacrylamide, N-methoxyethyl methacrylamide, N-butoxymethyl methacrylamide and acryloyl morpholine, diene compounds such as ethylidene norbornene, isoprene, pentadiene, vinylcyclohexene, chloroprene, butadiene, methyl butadiene and cyclobutadiene, and macromonomers having a radical polymerizable vinyl group. These polymerizable unsaturated compounds may be used alone or in combination thereof.

Among the compounds represented by the general formula (I), alkyl acrylates and alkyl methacrylates are preferable from the viewpoint of achieving both fluidity and curability, and aryl acrylates and aryl methacrylates are preferable from the viewpoint of achieving both fluidity and low hygroscopicity.

Specific examples of the compound represented by the general formula (II) include γ-methacryloxypropyltrimethoxysilane, γ-methacryloxypropyltriethoxysilane, γ-methacryloxypropylmethyldimethoxysilane, γ-methacryloxypropylmethyldiethoxysilane, γ-methacryloxypropyldimethylmethoxysilane, γ-methacryloxypropyldimethylethoxysilane, γ-acryloxypropyltrimethoxysilane, γ-acryloxypropyltriethoxysilane, γ-acryloxypropylmethyldimethoxysilane, γ-acryloxypropylmethyldiethoxysilane, γ-acryloxypropyldimethylmethoxysilane and γ-acryloxypropyldimethylethoxysilane. These polymerizable unsaturated compounds can be used alone or in combination thereof.

From the viewpoint of balance among fluidity, curability and adhesiveness, γ-methacryloxypropyltrimethoxysilane, γ-methacryloxypropylmethyldimethoxysilane, γ-acryloxypropyltrimethoxysilane and γ-acryloxypropylmethyldimethoxysilane are preferable, and γ-methacryloxypropyltrimethoxysilane and γ-methacryloxypropylmethyldimethoxysilane are more preferable.

The acrylic compound (C) used in the present invention is not particularly limited as long as it is a compound obtained by polymerizing compounds represented by the general formulae (I) and (II) wherein the mass ratio of (I) to (II) ((I)/(II)) is 0 to 10, and the acrylic compound wherein the mass ratio of (I)/(II) is smaller tends to be excellent in curability, and the acrylic compound wherein the mass ratio of (I)/(II) is larger tends to be excellent in fluidity. Particularly from the viewpoint of balance between fluidity and moldability, the mass ratio of (I)/(II) is preferably 0.05 to 8, more preferably 0.2 to 5. When the mass ratio of (I)/(II) is higher than 10, production of the acrylic compound is made difficult, and when the resulting acrylic compound is used, a sufficient effect cannot be achieved. When a plurality of compounds (I) or (II) are used, the (I)/(II) value is calculated from the average value.

The molecular weight of the acrylic compound (C) used in the present invention is not particularly limited insofar as the effect of the present invention is achieved, but from the viewpoint of the handleability of the acrylic compound and of achieving both the fluidity and curability of the epoxy resin molding material for sealing, the weight-average molecular weight (Mw) is preferably 5000 or less, more preferably 3000 or less. The Mw is determined with a standard curve using standard polystyrene in gel permeation chromatography (GPC). In the present invention, the Mw is determined by reference to measurement results in GPC using a pump (L-6200 manufactured by Hitachi, Ltd.), columns (trade names: TSKgel-G5000HXL and TSKgel-G2000HXL, manufactured by Tosoh Corporation) and a detector (L-3300RI manufactured by Hitachi, Ltd.) with tetrahydrofuran as an eluent under the conditions of a temperature of 30° C. and a flow rate of 1.0 ml/min.

The method of producing the acrylic compound (C) used in the present invention is not particularly limited insofar as the effect of the present invention is achieved, but a method of polymerizing polymerizable unsaturated compounds represented by the general formulae (I) and (II) in the presence of a metallocene compound and a thiol having a reactive silyl group in its molecule is preferable from the viewpoint of molecular weight regulation. Examples of the metallocene compound include a titanocene compound, a zirconocene compound, dicyclopentadienyl-V-chloride, bismethylcyclopentadienyl-V-chloride, bispentamethylcyclopentadienyl-V-chloride, dicyclopentadienyl-Ru-chloride and dicyclopentadienyl-Cr-chloride. The thiol having a reactive silyl group includes, for example, 3-mercaptopropyltrimethoxysilane, 3-mercaptopropyltriethoxysilane, 3-mercaptopropylmethyldimethoxysilane, 3-mercaptopropylphenyldimethoxysilane, 3-mercaptopropyldimethoxysilane, 3-mercaptopropylmonomethyldiethoxysilane, 4-mercaptobutyltrimethoxysilane and 3-mercaptobutyltrimethoxysilane.

When the acrylic compound (C) used in the present invention is synthesized, a multifunctional thiol compound prepared by esterifying ethyl mercaptan, butyl mercaptan, hexyl mercaptan, tert-dodecyl mercaptan, n-dodecyl mercaptan, octyl mercaptan, phenyl mercaptan, benzyl mercaptan, β-mercaptopropionic acid, mercaptoethanol, thiophenol, trithioglycerin or pentaerythritol with β-mercaptopropionic acid, a thiol compound such as a polysulfide polymer, or a sulfide compound such as diethyl trisulfide, dibutyl tetrasulfide, diphenyl disulfide, bis(2-hydroxyethyl)disulfide, bis(4-hydroxybutyl)tetrasulfide, bis(3-hydroxypropyl)trisulfide, bis(3-carboxypropyl)trisulfide, bis(3-carboxypropyl)tetrasulfide, bis(3-propyltrimethoxysilane)disulfide or bis(3-propyltriethoxysilane)tetrasulfide may be simultaneously used for the object of regulation of polymerization rate and polymerization degree, and these compounds may be used singly or in combination of two or more thereof.

AS-300 (manufactured by Soken Chemical & Engineering Co., Ltd.) wherein methyl methacrylate and γ-methacryloxypropyltrimethoxysilane were polymerized in a mass ratio of 1:1, AS-301 (manufactured by Soken Chemical & Engineering Co., Ltd.) wherein n-butyl methacrylate and γ-methacryloxypropyltrimethoxysilane were polymerized in a mass ratio of 3:1, and the like, are commercially available as examples of the acrylic compound (C) used in the present invention.

From the viewpoint of fluidity, moldability and reflow resistance, the total amount of the acrylic compound (C) incorporated in the present invention is preferably 0.03 to 0.8% by mass, more preferably 0.04 to 0.75% by mass, still more preferably 0.05 to 0.7% by mass, based on the epoxy resin molding material for sealing. When the amount is less than 0.03% by mass, the effect of the present invention tends to decrease, while when the amount is higher than 0.8% by mass, fluidity is improved, but reflow resistance tends to decrease.

The molding material of the present invention may contain a silane compound (D). The silane compound (D) includes various silane compounds such as epoxy silane, mercaptosilane, aminosilane, alkyl silane, ureido silane and vinyl silane, provided that the silane compound (D) excludes silane compounds overlapping with the acrylic compound (C).

Examples of such compounds include silane compounds such as vinyltrichlorosilane, vinyltrimethoxysilane, vinyltriethoxysilane, vinyltris(β-methoxyethoxy)silane, γ-methacryloxypropyltrimethoxysilane, γ-methacryloxypropyltriethoxysilane, γ-methacryloxypropylmethyldimethoxysilane, γ-methacryloxypropylmethyldiethoxysilane, γ-methacryloxypropyldimethylmethoxysilane, γ-methacryloxypropyldimethylethoxysilane, γ-acryloxypropyltrimethoxysilane, γ-acryloxypropyltriethoxysilane, β-(3,4-epoxycyclohexyl)ethyltrimethoxysilane, γ-glycidoxypropyltrimethoxysilane, γ-glycidoxypropyltriethoxysilane, γ-glycidoxypropylmethyldimethoxysilane, γ-glycidoxypropylmethyldiethoxysilane, γ-glycidoxypropyldimethylmethoxysilane, γ-glycidoxypropyldimethylethoxysilane, vinyltriacetoxysilane, γ-mercaptopropyltrimethoxysilane, γ-mercaptopropyltriethoxysilane, bis(triethoxysilylpropyl)tetrasulfide, γ-aminopropyltrimethoxysilane, γ-aminopropyltriethoxysilane, γ-[bis(β-hydroxyethyl)]aminopropyltriethoxysilane, N-β-(aminoethyl)-γ-aminopropyltriethoxysilane, N-(trimethoxysilylpropyl)ethylenediamine, isocyanate propyltrimethoxysilane, isocyanate propyltriethoxysilane, methyltrimethoxysilane, methyltriethoxysilane, dimethyldimethoxysilane, dimethyldiethoxysilane, phenyltrimethoxysilane, phenyltriethoxysilane, diphenyldimethoxysilane, diphenyldiethoxysilane, diphenylsilanediol, triphenylmethoxysilane, triphenylethoxysilane, triphenylsilanol, N-β-(N-vinylbenzylaminoethyl)-γ-aminopropyltrimethoxysilane, γ-chloropropyltrimethoxysilane, hexa methyldisilane, γ-anilinopropyltrimethoxysilane, γ-anilinopropyltriethoxysilane, 2-triethoxysilyl-N-(1,3-dimethyl-butylidene)propylamine, 3-triethoxysilyl-N-(1,3-dimethyl-butylidene)propylamine, N-(3-triethoxysilylpropyl)phenylimine, 3-(3-(triethoxysilyl) propylamino)-N,N-dimethylpropionamide, N-triethoxysilylpropyl-β-alanine methyl ester, 3-(triethoxysilylpropyl)dihydro-3,5-furandione, and bis(trimethoxysilyl)benzene, and

imidazole silane compounds that are reaction products between an imidazole compound such as 1H-imidazole, 2-alkyl imidazole, 2,4-dialkyl imidazole or 4-vinyl imidazole and γ-glycidoxypropylalkoxysilane such as γ-glycidoxypropyltrimethoxysilane or γ-glycidoxypropyltriethoxysilane. These compounds may be used alone or in combination of two or more thereof.

From the viewpoint of moldability and adhesiveness, the total amount of the silane compound (D) incorporated is preferably 0.06 to 2% by mass, more preferably 0.1 to 0.75% by mass, still more preferably 0.2 to 0.7% by mass, based on the epoxy resin molding material for sealing. When the amount is less than 0.06% by mass, adhesiveness to various package members tends to decrease, while when the amount is higher than 2% by mass, molding deficiency such as voids tends to occur easily.

The epoxy resin molding material for sealing according to the present invention may be compounded with a conventionally known coupling agent. Examples of the coupling agent include titanate coupling agents such as isopropyltriisostearoyl titanate, isopropyltris(dioctylpyrophosphate)titanate, isopropyltri(N-aminoethyl-aminoethyl)titanate, tetraoctylbis(ditridecylphosphate)titanate, tetra(2,2-diallyloxymethyl-1-butyl)bis(ditridecyl)phosphate titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropylisostearoyldiacryl titanate, isopropyltri(dioctylphosphate)titanate, isopropyltricumylphenyl titanate and tetraisopropylbis(dioctylphosphate)titanate, aluminum chelates, and aluminum/zirconium compounds, and these coupling agents may be used singly or in combination of two or more thereof. From the viewpoint of moldability and adhesiveness, the total amount of these coupling agents incorporated is preferably 0.06 to 2% by mass, more preferably 0.1 to 0.75% by mass, still more preferably 0.2 to 0.7% by mass, based on the epoxy resin molding material for sealing. When the amount is less than 0.06% by mass, adhesiveness to various package members tends to decrease, while when the amount is higher than 2% by mass, molding deficiency such as voids tends to occur easily.

The molding material of the present invention may contain a curing accelerator (E). The curing accelerator (E) used in the present invention is not particularly limited if it is a curing accelerator ordinarily used in epoxy resin molding materials for sealing. Examples thereof include cycloamidine compounds such as 1,8-diazabicyclo[5.4.0]undecene-7, 1,5-diaza-bicyclo[4.3.0]nonene-5, 5,6-dibutylamino-1,8-diaza-bicyclo[5.4.0]undecene-7, and compounds which each have intermolecular polarization and are obtained by adding, to any one of these compounds, a compound having a π bond such as maleic anhydride, a quinone compound such as 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone or phenyl-1,4-benzoquinone, diazophenylmethane or phenyl resin; tertiary amines and derivatives thereof such as benzyldimethylamine, triethanolamine, dimethylaminoethanol and tris(dimethylaminomethyl)phenol; imidazoles and derivatives thereof such as 2-methylimidazole, 2-phenylimidazole, 2-phenyl-4-methylimidazole and 2-heptadecylimidazole; organic phosphines such as tributylphosphine, methyldiphenylphosphine, triphenylphosphine, tris(4-methylphenyl)phosphine, diphenylphosphine and phenylphosphine, and phosphorus compounds which each have intermolecular polarization and are obtained by adding to any one of these phosphines a compound having a π bond such as maleic anhydride, anyone of the above-mentioned quinone compounds, diazophenylmethane or phenyl resin; tetra-substituted phosphonium tetra-substituted borate such as tetraphenyl phosphonium tetraphenyl borate, tetraphenyl phosphonium ethyl triphenyl borate and tetrabutyl phosphonium tetrabutyl borate; and tetraphenyl boron salts such as 2-ethyl-4-methylimidazole tetraphenyl borate and N-methylmorpholine tetraphenyl borate, and derivatives thereof. These may be used alone or in combination of two or more thereof.

In particular, an adduct of a tertiary phosphine and a quinone compound is preferred from the viewpoint of curability and fluidity, and from the viewpoint of storage stability, an adduct of a cycloamidine compound and phenol resin is preferable, and a novolac type phenol resin salt of diazabicycloundecene is more preferable.

The amount of these curing accelerators incorporated is preferably 60% by mass or more, more preferably 80% by mass or more, based on the total amount of the curing accelerator.

The tertiary phosphine used in the tertiary phosphine/quinone compound additive includes, but is not limited to, tertiary phosphine compounds having aryl groups, such as dibutylphenylphosphine, butyldiphenylphosphine, ethyldiphenylphosphine, triphenylphosphine, tris(4-methylphenyl)phosphine, tris(4-ethylphenyl)phosphine, tris(4-propylphenyl)phosphine, tris(4-butylphenyl)phosphine, tris(isopropylphenyl)phosphine, tris(tert-butylphenyl)phosphine, tris(2,4-dimethylphenyl)phosphine, tris(2,6-dimethylphenyl)phosphine, tris(2,4,6-trimethylphenyl)phosphine, tris(2,6-dimethyl-4-ethoxyphenyl)phosphine, tris(4-methoxyphenyl)phosphine and tris(4-ethoxyphenyl)phosphine, among which triphenylphosphine is preferable from the viewpoint of moldability.

The quinone compound used in the tertiary phosphine/quinone compound includes, but is not limited to, o-benzoquinone, p-benzoquinone, diphenoquinone, 1,4-naphthoquinone and anthraquinone, among which p-benzoquinone is preferable from the viewpoint of moisture resistance or storage stability.

The amount of the curing accelerator incorporated is not particularly limited as long as it is sufficient for showing a curing-acceleration effect, but the amount of the curing accelerator is preferably 0.1 to 10 parts by mass, more preferably 0.3 to 5 parts by mass, based on 100 parts by mass of the epoxy resin (A) and the curing agent (B). An amount of less than 0.1 part by mass may lead to deterioration in short-term hardening efficiency, while an amount of more than 10 parts by mass may lead to a too high hardening rate, thus making it difficult to obtain a favorable molded product.

The molding material of the present invention may contain an inorganic filler (F). The inorganic filler (F) used in the present invention is incorporated into the molding material in order to reduce hygroscopicity and linear expansion coefficient and to increase heat conductivity and strength, and is not particularly limited as long as it is generally used in epoxy resin molding materials for sealing. Examples thereof include powders of fused silica, crystalline silica, alumina, zircon, calcium silicate, calcium carbonate, potassium titanate, silicon carbide, silicon nitride, aluminum nitride, boron nitride, beryllia, zirconia, zircon, forsterite, steatite, spinel, mullite, titania, and the like; the spherical beads thereof, glass fiber, and the like. These inorganic fillers may be used alone or in combination of two or more. Among them, fused silica is preferable from the viewpoint of low linear expansion coefficient; alumina is preferable from the viewpoint of high heat conductivity; and the inorganic filler is preferably spherical in shape from the points of fluidity during molding and abrasion to mold. Particularly spherical fused silica is preferable from the viewpoint of the balance between cost and performance.

The amount of the inorganic filler incorporated into the epoxy resin molding material for sealing is preferably 70 to 95% by mass from the viewpoint of flame resistance, moldability, hygroscopicity, low linear expansion coefficient and high strength, more preferably 85 to 95% by mass from the viewpoint of hygroscopicity and low linear expansion coefficient. An amount of less than 70% by mass may lead to deterioration in flame retardancy and reflow resistance, while an amount of more than 95% by mass may lead to insufficient flowability.

An anion exchanger may also be added as necessary to the epoxy resin molding material for sealing according to the present invention, for the purpose of improvement in moisture resistance and high-temperature storage stability of IC. The anion exchanger is not particularly limited, and any one of known exchangers may be used. Examples thereof include hydrotalcites, and water-containing oxides of an element selected from magnesium, aluminum, titanium, zirconium, bismuth, and the like, and these compounds may be used alone or in combination of two or more. Among them, the hydrotalcites represented by the following compositional formula (XXV) are preferable.

(Formula 27)

Mg_{1-X}Al_{X}(OH)₂(CO₃)_{X/2}.mH₂O (XXV)

wherein 0<X≦0.5, and m is a positive number.

The amount of the anion exchanger incorporated is not particularly limited insofar as it is an amount enough to capture anions such as halogen ions, but is preferably 0.1 to 30 parts by mass, more preferably 1 to 5 parts by mass, based on 100 parts by mass of the epoxy resin (A).

For further improving adhesiveness, an adhesion promoter may be used if necessary in the epoxy resin molding material for sealing according to the present invention. Examples of the adhesion promoter include derivatives such as those of imidazole, triazole, tetrazole and triazine, anthranilic acid, gallic acid, malonic acid, malic acid, maleic acid, aminophenol, quinoline and derivatives thereof, aliphatic acid amide compounds, dithiocarbamate, and thiadiazole derivatives. These adhesive promoters may be used alone or as a mixture of two or more thereof.

If necessary, a release agent may be used in the epoxy resin molding material for sealing according to the present invention. An oxidized or non-oxidized polyolefin is used as a release agent in an amount of 0.01 to 10 parts by mass, more preferably 0.1 to 5 parts by mass, based on 100 parts by mass of the epoxy resin (A). When the amount is less than 0.01 part by mass, releasability tends to be insufficient, while when the amount is higher than 10 parts by mass, adhesiveness tends to decrease. The oxidized or non-oxidized polyolefin include low-molecular polyethylene having a number-average molecular weight of about 500 to 10000 such as H4, PE and PED series (manufactured by Hoechst Japan Ltd.). Examples of other release agents include carnauba wax, montanic acid esters, montanic acid, stearic acid etc., and these release agents may be used singly or in combination of two or more thereof. When these other release agents are used in combination with the oxidized or non-oxidized polyolefin, the total amount of the release agents incorporated is preferably 0.1 to 10 parts by mass, more preferably 0.5 to 3 parts by mass, based on 100 parts by mass of the epoxy resin (A).

The epoxy resin molding material for sealing according to the present invention can be compounded if necessary with a conventionally known flame retardant. Examples of the flame retardant include brominated epoxy resin, antimony trioxide, red phosphorus, red phosphorus coated with an inorganic material such as aluminum hydroxide, magnesium hydroxide or zinc oxide and/or a thermoplastic resin such a phenol resin, phosphorus compounds such as a phosphate, nitrogen-containing compounds such as melamine, a melamine derivative, a melamine-modified phenol resin, a compound having a triazine ring, a cyanuric acid derivative and an isocyanuric acid derivative, phosphorus- and nitrogen-containing compounds such as cyclophosphazene, metal hydroxides such as aluminum hydroxide and magnesium hydroxide, and composite metal hydroxides represented by the following compositional formula (XXVI):

(Formula 28)

p(M¹ₐO_{b}).q(M²_{c}O_{d}).r(M³ₑO_{f}).mH₂O (XXVI)

wherein M¹, M² and M³ represent metal elements different from one another, a, b, c, d, p, q and m each represent a positive number, and r represents either 0 or a positive number.

M¹, M² and M³ in the compositional formula (XXVI) are not particularly limited insofar as they are metal elements different from one another. From the viewpoint of flame retardancy, M¹ is preferably selected from the group consisting of metal elements belonging to the third period, alkaline earth metal elements of group IIA and metal elements belonging to groups IVB, IIB, VIII, IB, IIIA and IVA, and M² is preferably selected from transition metal elements of groups IIIB to IIB. The metal M¹ is more preferably selected from the group consisting of magnesium, calcium, aluminum, tin, titanium, iron, cobalt, nickel, copper and zinc, and M² is more preferably selected from the group consisting of iron, cobalt, nickel, copper and zinc. From the viewpoint of fluidity, M¹ is preferably magnesium, M² preferably zinc or nickel, and preferably r=0. The molar ratio of p, q and r is not particularly limited, but preferably r=0 and p/q is 1/99 to 1/1. The classification of the metal elements is based on the long form of the periodic table in which typical elements are to be in A subgroup and transition elements are to be in B subgroup. Other examples include metal element-containing compounds such as zinc oxide, zinc stannate, zinc borate, iron oxide, molybdenum oxide, zinc molybdate, and dicyclopentadienyl iron, and these flame retardants may be used singly or as a mixture of two or more thereof. The amount of the flame retardant incorporated is not particularly limited, but is preferably 1 to 30 parts by mass, more preferably 2 to 15 parts by mass, based on 100 parts by mass of the epoxy resin (A).

In addition, colorants such as carbon black, an organic dye, an organic pigment, titanium oxide, read lead and red oxide may be used in the epoxy resin molding material for sealing according to the present invention. A stress-relaxing agent such as silicone oil or silicone rubber powder may be incorporated if necessary as another additive.

The epoxy resin molding material for sealing according to the present invention can be prepared by any method that enables the various raw materials to be dispersed and mixed together uniformly, and typical methods include those in which predetermined blend quantities of the raw materials are mixed together thoroughly using a mixer or the like and subsequently subjected to melt mixing using mixing rollers or an extruder or the like, and the mixture is then cooled and ground. For example, the epoxy resin molding material for sealing can be obtained by a method wherein the predetermined amounts of the components are uniformly stirred, mixed and kneaded, cooled and ground using a kneader, rollers or an extruder previously heated at 70 to 140° C. Converting the product to tablets of dimensions and weight that are appropriate for the molding conditions facilitates use of the product.

Electronic component devices provided with elements sealed with the epoxy resin molding material for sealing obtained in the present invention include electronic component devices which load elements such as active elements (for example, semiconductor chip, transistor, diode, and thyristor) and passive elements (for example, capacitor, resistance, resistant array, coil and switch) onto a supporting member (for example, lead frame, wired tape carrier, circuit board, glass, and silicon wafer) whose necessary part(s) is sealed with the epoxy resin molding material for sealing according to the present invention.

Such electronic component devices include typical resin-sealed ICs such as DIP (Dual Inline Package), PLCC (Plastic Leaded Chip Carrier), QFP (Quad Flat package), SOP (Small Outline Package), SOJ (Small Outline J-lead Package), TSOP (Thin Small Outline Package), and TQFP (Thin Quad Flat Package) in which semiconductor components are secured to a lead frame, terminals of the component such as bonding pads and leads are connected by wire bonding or through bumps, and the component is then sealed by transfer molding or the like using the epoxy resin molding material for sealing according to the present invention; TCPs (Tape Carrier Packages) in which a semiconductor chip bonded to a tape carrier through bumps is sealed with the epoxy resin molding material for sealing according to the present invention; COB (Chip On Board) modules in which active elements such as a semiconductor chip, transistor, diode, or thyristor, and/or passive elements such as a capacitor, resistor, or coil which have been connected to wiring formed on a wiring board or glass sheet, by wire bonding, flip-chip bonding or soldering or the like, are sealed with the epoxy resin molding material for sealing according to the present invention; hybrid ICs; multichip modules; BGAs (Ball Grid Arrays) in which a component is mounted on an organic board having terminals for connection to a wiring board on the reverse, bumps or wire bonding are used to connect the component to wiring formed on the organic board, and the component is then sealed with the epoxy resin molding material for sealing according to the present invention; and CSP (Chip Size Package). The epoxy resin molding material for sealing according to the present invention can also be effectively used for printed circuit boards.

The most general method of sealing an element with the epoxy resin molding material for sealing according to the present invention is low-pressure transfer molding, but injection molding, compression molding etc. may also be used.

### EXAMPLES

Hereinafter, the present invention is described in more detail by reference to the Examples, but the present invention is not limited to these examples.

According to the Synthesis Examples below, (C) Acrylic Compounds 2, 3 and 5 to 11 were synthesized, and the weight-average molecular weight (Mw) and the molecular-weight distribution (Mw/Mn) were determined with a standard curve using standard polystyrene in gel permeation chromatography (GPC). In measurement, a pump (L-6200 manufactured by Hitachi, Ltd.), columns (trade names: TSKgel-G5000HXL and TSKgel-G2000HXL, manufactured by Tosoh Corporation) and a detector (L-3300RI manufactured by Hitachi, Ltd.) were used in GPC with tetrahydrofuran as an eluent under the conditions of a temperature of 30° C. and a flow rate of 1.0 ml/min.

### Synthesis Example 1

### Synthesis of Acrylic Compound 2

A flask equipped with a stirrer, a nitrogen gas inlet tube, a thermometer and a reflux condenser was charged with 100 g of benzyl methacrylate, 47 g of γ-methacryloxypropyltrimethoxysilane and 0.1 g of ruthenocene dichloride, and the mixture was heated to 80° C. in a nitrogen atmosphere. Then, 20 g of 3-mercaptopropyltrimethoxysilane was added all at once to the flask under stirring in a nitrogen atmosphere, and the mixture in the flask was stirred for 4 hours at a temperature kept at 80° C., and 20 g of 3-mercaptopropyltrimethoxysilane was added dropwise over 5 minutes to the flask under stirring in a nitrogen atmosphere, and the mixture in the flask was stirred for 4 hours at a temperature kept at 90° C. Subsequently, the temperature of the mixture in the flask was returned to room temperature, and after 20 g of a benzoquinone solution (95% by mass THF solution) was added to the reaction mixture which was then heated under reduced pressure (80° C./13 hPa) to remove low-boiling components, whereby an acrylic compound 2 (colorless transparent liquid, yield 75%, (I)/(II) mass ratio of about 2, Mw=1270, Mw/Mn=1.38, viscosity at 25° C.=1.91 Pa·S).

### Synthesis Example 2

### Synthesis of Acrylic Compound 3

An acrylic compound 3 (colorless transparent liquid, yield 81%, (I)/(II) mass ratio of about 0.7, Mw=1100, Mw/Mn=1.64, viscosity at 25° C.=0.26 Pa·S) was obtained in the same manner as in Synthesis Example 1 except that the amount of γ-methacryloxypropyltrimethoxysilane incorporated was 141 g.

### Synthesis Example 3

### Synthesis of Acrylic Compound 5

An acrylic compound 5 (colorless transparent liquid, yield 78%, (I)/(II) mass ratio of about 2, Mw=1100, Mw/Mn=1.51, viscosity at 25° C.=1.66 Pa·S) was obtained in the same manner as in Synthesis Example 1 except that 44 g of γ-methacryloxypropylmethyldimethoxysilane was used in place of γ-methacryloxypropyltrimethoxysilane.

### Synthesis Example 4

### Synthesis of Acrylic Compound 6

An acrylic compound 6 (colorless transparent liquid, yield 78%, (I)/(II) mass ratio of about 2, Mw=1150, Mw/Mn=1.68, viscosity at 25° C.=1.94 Pa·S) was obtained in the same manner as in Synthesis Example 1 except that 90 g of benzyl methacrylate and 12 g of acetoacetoxyethyl methacrylate were used in place of 100 g of benzyl methacrylate.

### Synthesis Example 5

### Synthesis of Acrylic Compound 7

An acrylic compound 7 (colorless transparent liquid, yield 81%, (I)/(II) mass ratio of about 9, Mw=1320, Mw/Mn=1.51, viscosity at 25° C.=0.08 Pa·S) was obtained in the same manner as in Synthesis Example 1 except that 90 g of lauryl methacrylate was used in place of 100 g of benzyl methacrylate, and 10 g of γ-methacryloxypropyltrimethoxysilane was used in place of 47 g of γ-methacryloxypropyltrimethoxysilane.

### Synthesis Example 6

### Synthesis of Acrylic Compound 8

An acrylic compound 8 (colorless transparent liquid, yield 80%, (I)/(II) mass ratio of about 9, Mw=1200, Mw/Mn=1.64, viscosity at 25° C.=0.86 Pa·S) was obtained in the same manner as in Synthesis Example 1 except that 90 g of tert-butyl acrylate was used in place of 100 g of benzyl methacrylate, and 10 g of γ-methacryloxypropyltrimethoxysilane was used in place of 47 g of γ-methacryloxypropyltrimethoxysilane.

### Synthesis Example 7

### Synthesis of Acrylic Compound 9

An acrylic compound 9 (colorless transparent liquid, yield 82%, (I)/(II) mass ratio of about 9, Mw=1100, Mw/Mn=1.45, viscosity at 25° C.=0.07 Pa·S) was obtained in the same manner as in Synthesis Example 1 except that 90 g of n-butyl acrylate was used in place of 100 g of benzyl methacrylate, and 10 g of γ-methacryloxypropyltrimethoxysilane was used in place of 47 g of γ-methacryloxypropyltrimethoxysilane.

### Synthesis Example 8

### Synthesis of Acrylic Compound 10

An acrylic compound 10 (colorless transparent liquid, yield 76%, (I)/(II) mass ratio of about 9, Mw=1100, Mw/Mn=1.35, viscosity at 25° C.=15.6 Pa·S) was obtained in the same manner as in Synthesis Example 1 except that 90 g of tert-butyl methacrylate was used in place of 100 g of benzyl methacrylate, and 10 g of γ-methacryloxypropyltrimethoxysilane was used in place of 47 g of γ-methacryloxypropyltrimethoxysilane.

### Synthesis Example 9

### Synthesis of Acrylic Compound 11

An acrylic compound 11 (colorless transparent liquid, yield 81%, (I)/(II) mass ratio of about 9, Mw=2000, Mw/Mn=1.89, viscosity at 25° C.=0.09 Pa·S) was obtained in the same manner as in Synthesis Example 1 except that 90 g of stearyl methacrylate was used in place of 100 g of benzyl methacrylate, and 10 g of γ-methacryloxypropyltrimethoxysilane was used in place of 47 g of γ-methacryloxypropyltrimethoxysilane.

### Examples 1 to 56 and Comparative Examples 1 to 17

The epoxy resin molding materials for sealing in Examples 1 to 56 and Comparative Examples 1 to 17 were prepared by mixing the components below in the parts by mass shown in Tables 1 to 9, Table 19 and Table 20 and roll-kneading the mixtures under the condition of a kneading temperature of 80° C. and a kneading time of 10 minutes. The blank in the table indicates that the corresponding component was not incorporated.

As the epoxy resin (A), the following resins were used:

an o-cresol novolac type epoxy resin having an epoxy equivalent of 200 and a softening point 67° C. (trade name: ESCN-190, manufactured by Sumitomo Chemical Co., Ltd.: epoxy resin 1);

a biphenyl type epoxy resin having an epoxy equivalent of 196 and a softening point of 106° C. (trade name: YX-4000H, manufactured by Japan Epoxy Resins Co., Ltd.: epoxy resin 2);

a biphenyl type epoxy resin having an epoxy equivalent of 176 and a softening point 111° C. (YL-6121H, manufactured by Japan Epoxy Resins Co., Ltd.; epoxy resin 3);

a thiodiphenol type epoxy resin having an epoxy equivalent of 242 and a softening point of 118° C. (trade name: YSLV-120TE, manufactured by Nippon Steel Chemical Co., Ltd.: epoxy resin 4);

a dicyclopentadiene type epoxy resin having an epoxy equivalent of 264 and a softening point of 64° C. (tradename: HP-7200, manufactured by Dainippon Ink and Chemicals, Inc.; epoxy resin 5);

a naphthalene type epoxy resin having an epoxy equivalent of 217 and a softening point of 72° C. (trade name: NC-7300, manufactured by Nippon Kayaku Co., Ltd.; epoxy resin 6);

a triphenylmethane type epoxy resin having an epoxy equivalent of 170 and a softening point of 65° C. (trade name: EPPN-502H, manufactured by Nippon Kayaku Co., Ltd.; epoxy resin 7);

a bisphenol F type epoxy resin having an epoxy equivalent of 192 and a softening point of 79° C. (tradename: YSLV-80XY, manufactured by Nippon Steel Chemical Co., Ltd.; epoxy resin 8);

a biphenylene skeleton-containing phenol-aralkyl type epoxy resin having an epoxy equivalent of 241 and a softening point of 96° C. (trade name: CER-3000L, manufactured by Nippon Kayaku Co., Ltd.; epoxy resin 9);

a β-naphthol-aralkyl type epoxy resin having an epoxy equivalent of 265 and a softening point of 66° C. (trade name: ESN-175S, manufactured by Nippon Steel Chemical Co., Ltd.; epoxy resin 10); and

a bisphenol A type brominated epoxy resin having an epoxy equivalent of 375, a softening point of 80° C. and a bromine content of 48% by mass (epoxy resin 11).

As the curing agent (B), the following resins were used:

a phenol-aralkyl resin having a hydroxyl equivalent of 199 and a softening point of 89° C. (trade name: MEH-7851, manufactured by Meiwa Plastic Industries, Ltd.; curing agent 1);

a phenol-aralkyl resin having a hydroxyl equivalent of 176 and a softening point of 70° C. (trade name: Milex XLC, manufactured by Mitsui Chemicals, Inc.; curing agent 2);

a naphthol-aralkyl resin having a hydroxyl equivalent of 183 and a softening point of 79° C. (trade name: SN-170, manufactured by Nippon Steel Chemical Co., Ltd.; curing agent 3);

a triphenylmethane type phenol resin having a hydroxyl equivalent of 104 and a softening point of 83° C. (tradename: MEH-7500, manufactured by Meiwa Plastic Industries, Ltd.; curing agent 4);

a novolac type phenol resin having a hydroxyl equivalent of 106 and a softening point of 64° C. (trade name: H-4, manufactured by Meiwa Plastic Industries, Ltd.; curing agent 5); and

a phenol resin having a hydroxyl equivalent of 156 and a softening point of 83° C. (trade name: HE-510, manufactured by Sumikin Air Water Chemical Inc.; curing agent 6).

γ-Glycidoxypropyltrimethoxysilane (silane compound 1) and γ-aminopropyltriethoxysilane (silane compound 2) were used as the silane compound (D); a betaine type adduct of triphenyl phosphine and p-benzoquinone (curing accelerator 1) and a betaine type adduct of tributyl phosphine and p-benzoquinone (curing accelerator 2) were used as the curing accelerator (E); spherical fused silica having an average particle size of 17.5 μm and a specific surface area of 3.8 m²/g was used as the inorganic filler (F); and other additive components were carnauba wax, antimony trioxide and carbon black.

The acrylic compound (C) used includes the acrylic compounds 2, 3 and 5 to 11 synthesized above; an acrylic compound having a Mw=1000 and a Mw/Mn=1.62 with a viscosity of 1.6 Pa·S at 25° C. wherein methyl methacrylate and γ-methacryloxypropyltrimethoxysilane were synthesized in a mass ratio of 1 (trade name: AS-300, manufactured by Soken Chemical & Engineering Co., Ltd.; acrylic compound 1); and an acrylic compound having a Mw=1400 and a Mw/Mn=1.62 with a viscosity of 0.8 Pa·S at 25° C. wherein n-butyl methacrylate and γ-methacryloxypropyltrimethoxysilane were synthesized in a ratio of 3 (trade name: AS-301, manufactured by Soken Chemical & Engineering Co., Ltd.; acrylic compound 4).

TABLE 1
composition 1

| | example | | | | | | |
|---|---|---|---|---|---|---|---|
| component | 1 | 2 | 3 | 4 | 5 | 6 | 7 |
| epoxy resin 1 | 85 | | | | | | |
| epoxy resin 2 | | 85 | 100 | 42.5 | | | |
| epoxy resin 3 | | | | | 85 | | |
| epoxy resin 4 | | | | | | 85 | 100 |
| epoxy resin 5 | | | | 42.5 | | | |
| epoxy resin 11 | 15 | 15 | | 15 | 15 | 15 | |
| curing agent 2 | | 83.4 | 89.8 | 73.5 | | 68.9 | 72.7 |
| curing agent 4 | | | | | 54.4 | | |
| curing agent 5 | 49.3 | | | | | | |
| silane compound 1 | 7.5 | 7.5 | 7.5 | 7.5 | 7.5 | 7.5 | 7.5 |
| acrylic compound 1 | 5.0 | 5.0 | 5.0 | 5.0 | 5.0 | 5.0 | 5.0 |
| curing | 2.8 | 3.5 | | 3.5 | 3.0 | 3.8 | 3.8 |
| accelerator 1 | | | | | | | |
| curing | | | 4.5 | | | | |
| accelerator 2 | | | | | | | |
| antimony trioxide | 6.0 | 6.0 | | 6.0 | 6.0 | 6.0 | |
| carnauba wax | 2 | 2 | 2 | 2 | 2 | 2 | 2 |
| carbon black | 1.5 | 1.5 | 1.5 | 1.5 | 1.5 | 1.5 | 1.5 |
| fused silica | 1277 | 1532 | 1577 | 1460 | 1316 | 1427 | 1444 |
| acrylic compound | 0.34 | 0.29 | 0.28 | 0.30 | 0.33 | 0.31 | 0.31 |
| in the total | | | | | | | |
| components (wt %) | | | | | | | |

TABLE 2
composition 2

| | example | | | | | | |
|---|---|---|---|---|---|---|---|
| component | 8 | 9 | 10 | 11 | 12 | 13 | 14 |
| epoxy resin 4 | 42.5 | 42.5 | | | | | |
| epoxy resin 5 | 42.5 | | | | | | |
| epoxy resin 6 | | 42.5 | | | | | |
| epoxy resin 7 | | | 85 | | | | |
| epoxy resin 8 | | | | 100 | 100 | 100 | |
| epoxy resin 9 | | | | | | | 100 |
| epoxy resin 11 | 15 | 15 | 15 | | | | |
| curing agent 1 | | | | 103.6 | 31.1 | | 82.2 |
| curing agent 2 | 66.3 | 72.4 | | | | | |
| curing agent 4 | | | 56.2 | | 37.9 | | |
| curing agent 6 | | | | | | 81.3 | |
| silane compound 1 | 7.5 | 7.5 | 7.5 | 7.5 | 7.5 | 7.5 | 7.5 |
| acrylic compound 1 | 5.0 | 5.0 | 5.0 | 5.0 | 5.0 | 5.0 | 5.0 |
| curing | 3.8 | 3.0 | 1.7 | 3.4 | | | |
| accelerator 1 | | | | | | | |
| curing | | | | | 4.5 | 5.0 | 3.0 |
| accelerator 2 | | | | | | | |
| antimony trioxide | 6.0 | 6.0 | 6.0 | | | | |
| carnauba wax | 2 | 2 | 2 | 2 | 2 | 2 | 2 |
| carbon black | 1.5 | 1.5 | 1.5 | 1.5 | 1.5 | 1.5 | 1.5 |
| fused silica | 1409 | 1448 | 1319 | 1636 | 1390 | 1483 | 1476 |
| acrylic compound | 0.31 | 0.30 | 0.33 | 0.27 | 0.32 | 0.30 | 0.30 |
| in the total | | | | | | | |
| components (wt %) | | | | | | | |

TABLE 3
composition 3

| | example | | | | | | |
|---|---|---|---|---|---|---|---|
| component | 15 | 16 | 17 | 18 | 19 | 20 | 21 |
| epoxy resin 2 | | | | 100 | | | |
| epoxy resin 4 | | | | | 100 | | |
| epoxy resin 8 | | | | | | 100 | 100 |
| epoxy resin 9 | 100 | 100 | | | | | |
| epoxy resin 10 | | | 100 | | | | |
| curing agent 1 | | | | | | 31.1 | |
| curing agent 2 | 72.7 | | 66.4 | 89.8 | 72.7 | | |
| curing agent 3 | | 86.4 | | | | | |
| curing agent 4 | | | | | | 37.9 | |
| curing agent 6 | | | | | | | 81.3 |
| silane compound 1 | 7.5 | 7.5 | 7.5 | 7.5 | 7.5 | 7.5 | 7.5 |
| acrylic compound 1 | 5.0 | 5.0 | 5.0 | | | | |
| acrylic compound 2 | | | | 5.0 | 5.0 | 5.0 | 5.0 |
| curing | 3.0 | 3.0 | 2.8 | | 3.8 | | |
| accelerator 1 | | | | | | | |
| curing | | | | 4.5 | | 4.5 | 5.0 |
| accelerator 2 | | | | | | | |
| carnauba wax | 2 | 2 | 2 | 2 | 2 | 2 | 2 |
| carbon black | 1.5 | 1.5 | 1.5 | 1.5 | 1.5 | 1.5 | 1.5 |
| fused silica | 1406 | 1506 | 1358 | 1577 | 1444 | 1390 | 1483 |
| acrylic compound | 0.31 | 0.29 | 0.32 | 0.28 | 0.31 | 0.32 | 0.30 |
| in the total | | | | | | | |
| components (wt %) | | | | | | | |

TABLE 4
composition 4

| | example | | | | | | |
|---|---|---|---|---|---|---|---|
| component | 22 | 23 | 24 | 25 | 26 | 27 | 28 |
| epoxy resin 2 | | | | 100 | | | |
| epoxy resin 4 | | | | | 100 | | |
| epoxy resin 8 | | | | | | 100 | 100 |
| epoxy resin 9 | 100 | 100 | | | | | |
| epoxy resin 10 | | | 100 | | | | |
| curing agent 1 | 82.2 | | | | | 31.1 | |
| curing agent 2 | | 72.7 | 66.4 | 89.8 | 72.7 | | |
| curing agent 4 | | | | | | 37.9 | |
| curing agent 6 | | | | | | | 81.3 |
| silane compound 1 | 7.5 | 7.5 | 7.5 | 7.5 | 7.5 | 7.5 | 7.5 |
| acrylic compound 2 | 5.0 | 5.0 | 5.0 | | | | |
| acrylic compound 3 | | | | 5.0 | 5.0 | 5.0 | 5.0 |
| curing | | 3.0 | 2.8 | | 3.8 | | |
| accelerator 1 | | | | | | | |
| curing | 3.0 | | | 4.5 | | 4.5 | 5.0 |
| accelerator 2 | | | | | | | |
| carnauba wax | 2 | 2 | 2 | 2 | 2 | 2 | 2 |
| carbon black | 1.5 | 1.5 | 1.5 | 1.5 | 1.5 | 1.5 | 1.5 |
| fused silica | 1476 | 1406 | 1358 | 1577 | 1444 | 1390 | 1483 |
| acrylic compound | 0.30 | 0.31 | 0.32 | 0.28 | 0.31 | 0.32 | 0.30 |
| in the total | | | | | | | |
| components (wt %) | | | | | | | |

TABLE 5
composition 5

| | example | | | | | | |
|---|---|---|---|---|---|---|---|
| component | 29 | 30 | 31 | 32 | 33 | 34 | 35 |
| epoxy resin 2 | | 100 | | | | | |
| epoxy resin 4 | | | 100 | | | | |
| epoxy resin 8 | | | | 100 | 100 | | |
| epoxy resin 9 | 100 | | | | | 100 | |
| epoxy resin 10 | | | | | | | 100 |
| curing agent 1 | | | | 31.1 | | | |
| curing agent 2 | 72.7 | 89.8 | 72.7 | | | 72.7 | 66.4 |
| curing agent 4 | | | | 37.9 | | | |
| curing agent 6 | | | | | 81.3 | | |
| silane compound 1 | 7.5 | 7.5 | 7.5 | 7.5 | 7.5 | 7.5 | 7.5 |
| acrylic compound 3 | 5.0 | | | | | | |
| acrylic compound 4 | | 5.0 | 5.0 | 5.0 | 5.0 | 5.0 | 5.0 |
| curing | 3.0 | | 3.8 | | | 3.0 | 2.8 |
| accelerator 1 | | | | | | | |
| curing | | 4.5 | | 4.5 | 5.0 | | |
| accelerator 2 | | | | | | | |
| carnauba wax | 2 | 2 | 2 | 2 | 2 | 2 | 2 |
| carbon black | 1.5 | 1.5 | 1.5 | 1.5 | 1.5 | 1.5 | 1.5 |
| fused silica | 1406 | 1577 | 1444 | 1390 | 1483 | 1406 | 1358 |
| acrylic compound | 0.31 | 0.28 | 0.31 | 0.32 | 0.30 | 0.31 | 0.32 |
| in the total | | | | | | | |
| components (wt %) | | | | | | | |

TABLE 6
composition 6

| | example | | | | | | | |
|---|---|---|---|---|---|---|---|---|
| component | 36 | 37 | 38 | 39 | 40 | 41 | 42 | 43 |
| epoxy resin 2 | 100 | | | | | | 85 | 85 |
| epoxy resin 4 | | 100 | | | | | | |
| epoxy resin 8 | | | 100 | 100 | | | | |
| epoxy resin 9 | | | | | 100 | | | |
| epoxy resin 10 | | | | | | 100 | | |
| epoxy resin 11 | | | | | | | 15 | 15 |
| curing agent 1 | | | 31.1 | | | | | |
| curing agent 2 | 89.8 | 72.7 | | | 72.7 | 66.4 | 83.4 | 83.4 |
| curing agent 4 | | | 37.9 | | | | | |
| curing agent 6 | | | | 81.3 | | | | |
| silane compound 1 | 7.5 | 7.5 | 7.5 | 7.5 | 7.5 | 7.5 | 7.5 | 7.5 |
| acrylic compound 1 | | | | | | | 3.0 | 8.0 |
| acrylic compound 5 | 5.0 | 5.0 | 5.0 | 5.0 | 5.0 | 5.0 | | |
| curing | | 3.8 | | | 3.0 | 2.8 | 3.5 | 3.5 |
| accelerator 1 | | | | | | | | |
| curing | 4.5 | | 4.5 | 5.0 | | | | |
| accelerator 2 | | | | | | | | |
| antimony trioxide | | | | | | | 6.0 | 6.0 |
| carnauba wax | 2 | 2 | 2 | 2 | 2 | 2 | 2 | 2 |
| carbon black | 1.5 | 1.5 | 1.5 | 1.5 | 1.5 | 1.5 | 1.5 | 1.5 |
| fused silica | 1577 | 1444 | 1390 | 1483 | 1406 | 1358 | 1517 | 1554 |
| acrylic compound | 0.28 | 0.31 | 0.32 | 0.30 | 0.31 | 0.32 | 0.17 | 0.45 |
| in the total | | | | | | | | |
| components (wt %) | | | | | | | | |

TABLE 7
composition 7

| | comparative example | | | | | | |
|---|---|---|---|---|---|---|---|
| component | 1 | 2 | 3 | 4 | 5 | 6 | 7 |
| epoxy resin 1 | 85 | | | | | | |
| epoxy resin 2 | | 85 | 100 | 42.5 | | | |
| epoxy resin 3 | | | | | 85 | | |
| epoxy resin 4 | | | | | | 85 | 100 |
| epoxy resin 5 | | | | 42.5 | | | |
| epoxy resin 11 | 15 | 15 | | 15 | 15 | 15 | |
| curing agent 2 | | 83.4 | 89.8 | 73.5 | | 68.9 | 72.7 |
| curing agent 4 | | | | | 54.4 | | |
| curing agent 5 | 49.3 | | | | | | |
| silane compound 1 | 7.5 | | | | | | |
| silane compound 2 | | 7.5 | 7.5 | 7.5 | 7.5 | 7.5 | 7.5 |
| curing | 2.8 | 3.5 | | 3.5 | 3.0 | 3.8 | 3.8 |
| accelerator 1 | | | | | | | |
| curing | | | 4.5 | | | | |
| accelerator 2 | | | | | | | |
| antimony trioxide | 6.0 | 6.0 | | 6.0 | 6.0 | 6.0 | |
| carnauba wax | 2 | 2 | 2 | 2 | 2 | 2 | 2 |
| carbon black | 1.5 | 1.5 | 1.5 | 1.5 | 1.5 | 1.5 | 1.5 |
| fused silica | 1240 | 1495 | 1540 | 1423 | 1279 | 1391 | 1406 |
| acrylic compound | 0.00 | 0.00 | 0.00 | 0.00 | 0.00 | 0.00 | 0.00 |
| in the total | | | | | | | |
| components (wt %) | | | | | | | |

TABLE 8
composition 8

| | comparative example | | | | | | |
|---|---|---|---|---|---|---|---|
| component | 8 | 9 | 10 | 11 | 12 | 13 | 14 |
| epoxy resin 4 | 43 | 43 | | | | | |
| epoxy resin 5 | 43 | | | | | | |
| epoxy resin 6 | | 43 | | | | | |
| epoxy resin 7 | | | 85 | | | | |
| epoxy resin 8 | | | | 100 | 100 | 100 | |
| epoxy resin 9 | | | | | | | 100 |
| epoxy resin 11 | 15 | 15 | 15 | | | | |
| curing agent 1 | | | | 103.6 | 31.1 | | 82.2 |
| curing agent 2 | 66.3 | 72.4 | | | | | |
| curing agent 4 | | | 56.2 | | 37.9 | | |
| curing agent 6 | | | | | | 81.3 | |
| silane compound 1 | 7.5 | | 7.5 | | | | |
| silane compound 2 | | 7.5 | | 7.5 | 7.5 | 7.5 | 7.5 |
| curing | 3.8 | 3.0 | 1.7 | 3.4 | | | |
| accelerator 1 | | | | | | | |
| curing | | | | | 4.5 | 5.0 | 3.0 |
| accelerator 2 | | | | | | | |
| antimony trioxide | 6.0 | 6.0 | 6.0 | | | | |
| carnauba wax | 2 | 2 | 2 | 2 | 2 | 2 | 2 |
| carbon black | 1.5 | 1.5 | 1.5 | 1.5 | 1.5 | 1.5 | 1.5 |
| fused silica | 1372 | 1411 | 1282 | 1599 | 1353 | 1447 | 1439 |
| acrylic compound | 0.00 | 0.00 | 0.00 | 0.00 | 0.00 | 0.00 | 0.00 |
| in the total | | | | | | | |
| components (wt %) | | | | | | | |

TABLE 9
composition 9

| | comparative example | | |
|---|---|---|---|
| component | 15 | 16 | 17 |
| epoxy resin 9 | 100 | 100 | |
| epoxy resin 10 | | | 100 |
| curing agent 2 | 72.7 | | 66.4 |
| curing agent 3 | | 86.4 | |
| silane compound 2 | 7.5 | 7.5 | 7.5 |
| curing | 3.0 | 3.0 | 2.8 |
| accelerator 1 | | | |
| carnauba wax | 2 | 2 | 2 |
| carbon black | 1.5 | 1.5 | 1.5 |
| fused silica | 1369 | 1469 | 1322 |
| acrylic compound | 0.00 | 0.00 | 0.00 |
| in the total | | | |
| components (wt %) | | | |

The epoxy resin molding materials for sealing in the Examples and Comparative Examples were evaluated according to Characteristic Tests (1) to (8) below. The evaluation results are shown in Tables 10 to 18, 21 and 22. Unless otherwise noted, molding of the epoxy resin molding materials for sealing was carried out using a transfer molding machine under the conditions of a mold temperature of 180° C., a molding pressure of 6.9 MPa and a curing time of 90 seconds. Post-curing was carried out at 180° C. for 5 hours.

(1) Spiral Flow

Using a mold for measuring spiral flow in accordance with EMMI-1-66, each molding material for sealing was molded under the conditions described above, and the flow distance (cm) was determined.

(2) Disc Flow

5 g of the epoxy resin molding material for sealing was weighed out with an even balance. A disc flow measuring planar mold having a top part of 200 mm (W)×200 mm (D)×25 mm (H) and a bottom part of 200 mm (W)×200 mm (D)×15 mm (H) was used, and the weighed sample, 5 g, was put on the center of the bottom part heated to 180° C., and 5 seconds thereafter, the top part heated to 180° C. was tightened thereon, and then the sample was compression-molded at a load of 78 N for a curing time of 90 seconds. The long diameter (mm) and the short diameter (mm) of the molded product were measured with a vernier micrometer. The average value (mm) thereof was defined as the disc flow.

(3) Hardness at Hot Time

The epoxy resin molding material for sealing was molded into a disc having a diameter of 50 mm and a thickness of 3 mm under the above-mentioned conditions. Immediately after the material was molded, the hardness thereof was measured with a Shore D hardness meter (HD1120 (type D) manufactured by Ueshima Seisakusho Co., Ltd.)

(4) Adhesion Storage

The epoxy resin molding material for sealing was molded on a 30-μm aluminum foil and post-cured to prepare a test specimen. Before and after PCT treatment (121° C., 0.2 MPa, 100 hours), the test specimen was measured for its peel strength (N/m) in a direction of 90° C. The adhesion storage was determined according to the equation: Adhesion storage (%)=aluminum peel strength after PCT treatment/aluminum peel strength before PCT treatment×100.

(5) Reflow Soldering Resistance

Using the epoxy resin molding material for sealing, an 80-pin flat package with external dimensions with 20 mm×14 mm×2 mm mounted with a silicon chip with dimensions 8 mm×10 mm fabricated on a 42-alloy lead frame was prepared by molding and post-curing under the conditions described above. After humidification at 85° C. and 85% RH, a reflow treatment was conducted at 240° C. for 10 seconds at a particular time interval, and the package was then inspected for the presence of cracking. The reflow resistance was evaluated as the number of cracked packages relative to the number (10) of packages tested.

(6) Water Absorption

The disc molded in (3) above was post-cured under the conditions shown above and then left under the conditions of 85° C. and 85% RH for 72 hours, and the change in the mass of the disk after and before it had been left was measured. The water absorption was determined according to the equation: Water absorption (mass %)={(mass of the disc after left−mass of the disc before left)/mass of the disc before left}×100.

(7) Glass Transition Temperature (Tg)

The epoxy resin molding material for sealing was molded in a shape of 19 mm×3 mm×3 mm and post-cured under the above conditions to prepare a test specimen. The test specimen was measured at a heating rate of 5° C./min to determine its glass transition temperature (Tg, unit; ° C.) from an inflection point in a linear expansion curve with a thermo-mechanical analyzer (TMA-8140, TAS-100, produced by Rigaku Corporation).

(8) Flame Retardancy

By using a mold for molding a sample specimen having a thickness of 1/16 inch (about 1.6 mm), the epoxy resin molding material for sealing was molded and post-cured under the conditions described above, and then the flame retardancy thereof was evaluated according to the test method of UL-94.

TABLE 10
evaluation result 1

| | example | | | | | | |
|---|---|---|---|---|---|---|---|
| evaluation item | 1 | 2 | 3 | 4 | 5 | 6 | 7 |
| Spiral Flow (cm) | 91 | 123 | 96 | 119 | 108 | 121 | 94 |
| Disc Flow (mm) | 81 | 95 | 89 | 98 | 102 | 98 | 91 |
| Hardness at | 83 | 80 | 83 | 80 | 83 | 80 | 83 |
| Hot Time | | | | | | | |
| Adhesion Storage | 86 | 91 | 88 | 91 | 88 | 92 | 89 |
| (%) | | | | | | | |
| Reflow Soldering | | | | | | | |
| Resistance | | | | | | | |
| 24 h | 0/10 | 0/10 | 0/10 | 0/10 | 0/10 | 0/10 | 0/10 |
| 48 h | 0/10 | 0/10 | 0/10 | 0/10 | 0/10 | 0/10 | 0/10 |
| 72 h | 1/10 | 0/10 | 0/10 | 0/10 | 0/10 | 0/10 | 0/10 |
| Water Absorption | 0.16 | 0.15 | 0.14 | 0.15 | 0.15 | 0.15 | 0.14 |
| (%) | | | | | | | |
| Tg (° C.) | 141 | 119 | 115 | 124 | 133 | 118 | 114 |
| Flame Retardancy | V-0 | V-0 | V-0 | V-0 | V-0 | V-0 | V-0 |

TABLE 11
evaluation result 2

| | example | | | | | | |
|---|---|---|---|---|---|---|---|
| evaluation item | 8 | 9 | 10 | 11 | 12 | 13 | 14 |
| Spiral Flow (cm) | 100 | 105 | 95 | 117 | 134 | 107 | 98 |
| Disc Flow (mm) | 87 | 91 | 83 | 96 | 103 | 99 | 93 |
| Hardness at | 82 | 80 | 84 | 84 | 84 | 83 | 83 |
| Hot Time | | | | | | | |
| Adhesion Storage | 90 | 90 | 85 | 90 | 88 | 89 | 89 |
| (%) | | | | | | | |
| Reflow Soldering | | | | | | | |
| Resistance | | | | | | | |
| 24 h | 0/10 | 0/10 | 0/10 | 0/10 | 0/10 | 0/10 | 0/10 |
| 48 h | 0/10 | 0/10 | 0/10 | 0/10 | 0/10 | 0/10 | 0/10 |
| 72 h | 0/10 | 0/10 | 2/10 | 0/10 | 0/10 | 0/10 | 0/10 |
| Water Absorption | 0.14 | 0.14 | 0.17 | 0.14 | 0.14 | 0.15 | 0.14 |
| (%) | | | | | | | |
| Tg (° C.) | 122 | 131 | 156 | 117 | 143 | 118 | 115 |
| Flame Retardancy | V-0 | V-0 | V-0 | V-0 | V-0 | V-0 | V-0 |

TABLE 12
evaluation result 3

| | example | | | | | | |
|---|---|---|---|---|---|---|---|
| evaluation item | 15 | 16 | 17 | 18 | 19 | 20 | 21 |
| Spiral Flow (cm) | 98 | 101 | 115 | 100 | 98 | 138 | 111 |
| Disc Flow (mm) | 93 | 96 | 90 | 93 | 95 | 105 | 102 |
| Hardness at | 84 | 83 | 81 | 83 | 83 | 84 | 83 |
| Hot Time | | | | | | | |
| Adhesion Storage | 90 | 90 | 89 | 90 | 91 | 90 | 91 |
| (%) | | | | | | | |
| Reflow Soldering | | | | | | | |
| Resistance | | | | | | | |
| 24 h | 0/10 | 0/10 | 0/10 | 0/10 | 0/10 | 0/10 | 0/10 |
| 48 h | 0/10 | 0/10 | 0/10 | 0/10 | 0/10 | 0/10 | 0/10 |
| 72 h | 0/10 | 0/10 | 0/10 | 0/10 | 0/10 | 0/10 | 0/10 |
| Water Absorption | 0.14 | 0.14 | 0.14 | 0.14 | 0.14 | 0.14 | 0.15 |
| (%) | | | | | | | |
| Tg (° C.) | 116 | 116 | 124 | 114 | 113 | 142 | 117 |
| Flame Retardancy | V-0 | V-0 | V-0 | V-0 | V-0 | V-0 | V-0 |

TABLE 13
evaluation result 4

| | example | | | | | | |
|---|---|---|---|---|---|---|---|
| evaluation item | 22 | 23 | 24 | 25 | 26 | 27 | 28 |
| Spiral Flow (cm) | 102 | 102 | 119 | 97 | 95 | 135 | 108 |
| Disc Flow (mm) | 97 | 96 | 94 | 90 | 92 | 103 | 100 |
| Hardness at | 83 | 84 | 81 | 84 | 84 | 85 | 84 |
| Hot Time | | | | | | | |
| Adhesion Storage | 91 | 92 | 91 | 90 | 91 | 90 | 91 |
| (%) | | | | | | | |
| Reflow Soldering | | | | | | | |
| Resistance | | | | | | | |
| 24 h | 0/10 | 0/10 | 0/10 | 0/10 | 0/10 | 0/10 | 0/10 |
| 48 h | 0/10 | 0/10 | 0/10 | 0/10 | 0/10 | 0/10 | 0/10 |
| 72 h | 0/10 | 0/10 | 0/10 | 0/10 | 0/10 | 0/10 | 0/10 |
| Water Absorption | 0.14 | 0.14 | 0.14 | 0.14 | 0.14 | 0.14 | 0.15 |
| (%) | | | | | | | |
| Tg (° C.) | 114 | 115 | 122 | 115 | 114 | 143 | 118 |
| Flame Retardancy | V-0 | V-0 | V-0 | V-0 | V-0 | V-0 | V-0 |

TABLE 14
evaluation result 5

| | example | | | | | | |
|---|---|---|---|---|---|---|---|
| evaluation item | 29 | 30 | 31 | 32 | 33 | 34 | 35 |
| Spiral Flow (cm) | 98 | 100 | 98 | 138 | 111 | 102 | 119 |
| Disc Flow (mm) | 94 | 93 | 95 | 105 | 102 | 96 | 94 |
| Hardness at | 85 | 83 | 83 | 84 | 83 | 84 | 81 |
| Hot Time | | | | | | | |
| Adhesion Storage | 92 | 90 | 91 | 90 | 91 | 92 | 91 |
| (%) | | | | | | | |
| Reflow Soldering | | | | | | | |
| Resistance | | | | | | | |
| 24 h | 0/10 | 0/10 | 0/10 | 0/10 | 0/10 | 0/10 | 0/10 |
| 48 h | 0/10 | 0/10 | 0/10 | 0/10 | 0/10 | 0/10 | 0/10 |
| 72 h | 0/10 | 0/10 | 0/10 | 0/10 | 0/10 | 0/10 | 0/10 |
| Water Absorption | 0.14 | 0.14 | 0.14 | 0.14 | 0.15 | 0.14 | 0.14 |
| (%) | | | | | | | |
| Tg (° C.) | 116 | 114 | 113 | 142 | 117 | 115 | 123 |
| Flame Retardancy | V-0 | V-0 | V-0 | V-0 | V-0 | V-0 | V-0 |

TABLE 15
evaluation result 6

| | example | | | | | | | |
|---|---|---|---|---|---|---|---|---|
| evaluation item | 36 | 37 | 38 | 39 | 40 | 41 | 42 | 43 |
| Spiral Flow (cm) | 100 | 98 | 138 | 111 | 102 | 119 | 120 | 124 |
| Disc Flow (mm) | 93 | 95 | 105 | 102 | 96 | 94 | 95 | 96 |
| Hardness at | 82 | 82 | 84 | 83 | 83 | 80 | 80 | 81 |
| Hot Time | | | | | | | | |
| Adhesion Storage | 91 | 92 | 91 | 92 | 93 | 93 | 91 | 88 |
| (%) | | | | | | | | |
| Reflow Soldering | | | | | | | | |
| Resistance | | | | | | | | |
| 24 h | 0/10 | 0/10 | 0/10 | 0/10 | 0/10 | 0/10 | 0/10 | 0/10 |
| 48 h | 0/10 | 0/10 | 0/10 | 0/10 | 0/10 | 0/10 | 0/10 | 0/10 |
| 72 h | 0/10 | 0/10 | 0/10 | 0/10 | 0/10 | 0/10 | 0/10 | 0/10 |
| Water Absorption | 0.14 | 0.14 | 0.14 | 0.15 | 0.14 | 0.14 | 0.15 | 0.15 |
| (%) | | | | | | | | |
| Tg (° C.) | 113 | 113 | 143 | 116 | 114 | 123 | 119 | 118 |
| Flame Retardancy | V-0 | V-0 | V-0 | V-0 | V-0 | V-0 | V-0 | V-0 |

TABLE 16
evaluation result 7

| | comparative example | | | | | | |
|---|---|---|---|---|---|---|---|
| evaluation item | 1 | 2 | 3 | 4 | 5 | 6 | 7 |
| Spiral Flow (cm) | 72 | 65 | 55 | 67 | 61 | 65 | 55 |
| Disc Flow (mm) | 63 | 62 | 53 | 64 | 58 | 62 | 53 |
| Hardness at | 83 | 78 | 82 | 78 | 82 | 78 | 82 |
| Hot Time | | | | | | | |
| Adhesion Storage | 67 | 73 | 68 | 73 | 68 | 74 | 69 |
| (%) | | | | | | | |
| Reflow Soldering | | | | | | | |
| Resistance | | | | | | | |
| 24 h | 0/10 | 0/10 | 0/10 | 0/10 | 0/10 | 0/10 | 0/10 |
| 48 h | 6/10 | 1/10 | 1/10 | 1/10 | 4/10 | 1/10 | 1/10 |
| 72 h | 10/10 | 5/10 | 4/10 | 5/10 | 8/10 | 5/10 | 4/10 |
| Water Absorption | 0.17 | 0.15 | 0.15 | 0.15 | 0.15 | 0.15 | 0.15 |
| (%) | | | | | | | |
| Tg (° C.) | 140 | 118 | 115 | 123 | 132 | 117 | 114 |
| Flame Retardancy | V-0 | V-0 | V-0 | V-0 | V-0 | V-0 | V-0 |

TABLE 17
evaluation result 8

| | comparative example | | | | | | |
|---|---|---|---|---|---|---|---|
| evaluation item | 8 | 9 | 10 | 11 | 12 | 13 | 14 |
| Spiral Flow (cm) | 82 | 59 | 78 | 60 | 72 | 60 | 54 |
| Disc Flow (mm) | 71 | 56 | 67 | 57 | 68 | 57 | 49 |
| Hardness at | 80 | 78 | 83 | 83 | 81 | 83 | 82 |
| Hot Time | | | | | | | |
| Adhesion Storage | 72 | 72 | 66 | 69 | 70 | 68 | 68 |
| (%) | | | | | | | |
| Reflow Soldering | | | | | | | |
| Resistance | | | | | | | |
| 24 h | 0/10 | 0/10 | 0/10 | 0/10 | 0/10 | 0/10 | 0/10 |
| 48 h | 0/10 | 2/10 | 2/10 | 1/10 | 1/10 | 1/10 | 1/10 |
| 72 h | 5/10 | 6/10 | 7/10 | 5/10 | 6/10 | 6/10 | 5/10 |
| Water Absorption | 0.14 | 0.14 | 0.17 | 0.14 | 0.15 | 0.15 | 0.14 |
| (%) | | | | | | | |
| Tg (° C.) | 122 | 130 | 155 | 116 | 143 | 117 | 116 |
| Flame Retardancy | V-0 | V-0 | V-0 | V-0 | V-0 | V-0 | V-0 |

TABLE 18
evaluation result 9

| | comparative example | | |
|---|---|---|---|
| evaluation item | 15 | 16 | 17 |
| Spiral Flow (cm) | 54 | 57 | 60 |
| Disc Flow (mm) | 49 | 54 | 58 |
| Hardness at | 84 | 83 | 79 |
| Hot Time | | | |
| Adhesion Storage | 69 | 69 | 68 |
| (%) | | | |
| Reflow Soldering | | | |
| Resistance | | | |
| 24 h | 0/10 | 0/10 | 0/10 |
| 48 h | 1/10 | 1/10 | 1/10 |
| 72 h | 5/10 | 5/10 | 5/10 |
| Water Absorption | 0.14 | 0.14 | 0.15 |
| (%) | | | |
| Tg (° C.) | 116 | 116 | 122 |
| Flame Retardancy | V-0 | V-0 | V-0 |

TABLE 19
composition 10

| | example | | | | | | | |
|---|---|---|---|---|---|---|---|---|
| component | 44 | 45 | 46 | 47 | 48 | 49 | 50 | 51 |
| epoxy resin 2 | 100 | | | | | | 85 | 85 |
| epoxy resin 4 | | 100 | | | | | | |
| epoxy resin 8 | | | 100 | 100 | | | | |
| epoxy resin 9 | | | | | 100 | | | |
| epoxy resin 10 | | | | | | 100 | | |
| epoxy resin 11 | | | | | | | 15 | 15 |
| curing agent 1 | | | 31.1 | | | | | |
| curing agent 2 | 89.8 | 72.7 | | | 72.7 | 66.4 | 83.4 | 83.4 |
| curing agent 4 | | | 37.9 | | | | | |
| curing agent 6 | | | | 81.3 | | | | |
| silane | 7.5 | 7.5 | 7.5 | 7.5 | 7.5 | 7.5 | 7.5 | 7.5 |
| compound 1 | | | | | | | | |
| Acrylic | | | | | | | 0.4 | 15.0 |
| compound 2 | | | | | | | | |
| Acrylic | 5.0 | 5.0 | 5.0 | 5.0 | 5.0 | 5.0 | | |
| compound 6 | | | | | | | | |
| curing | | 3.8 | | | 3.0 | 2.8 | 3.5 | 3.5 |
| accelerator 1 | | | | | | | | |
| curing | 4.5 | | 4.5 | 5.0 | | | | |
| accelerator 2 | | | | | | | | |
| antimony | | | | | | | 6.0 | 6.0 |
| trioxide | | | | | | | | |
| carnauba wax | 2 | 2 | 2 | 2 | 2 | 2 | 2 | 2 |
| carbon black | 1.5 | 1.5 | 1.5 | 1.5 | 1.5 | 1.5 | 1.5 | 1.5 |
| fused silica | 1577 | 1444 | 1390 | 1483 | 1406 | 1358 | 1498 | 1605 |
| acrylic compound | 0.28 | 0.31 | 0.32 | 0.30 | 0.31 | 0.32 | 0.02 | 0.82 |
| in the total | | | | | | | | |
| components (wt %) | | | | | | | | |

TABLE 20
composition 11

| | example | | | | |
|---|---|---|---|---|---|
| component | 52 | 53 | 54 | 55 | 56 |
| epoxy resin 2 | 100 | 100 | 100 | 100 | 100 |
| curing agent 2 | 89.8 | 89.8 | 89.8 | 89.8 | 89.8 |
| silane compound 1 | 7.5 | 7.5 | 7.5 | 7.5 | 7.5 |
| acrylic compound 7 | 5.0 | | | | |
| acrylic compound 8 | | 5.0 | | | |
| acrylic compound 9 | | | 5.0 | | |
| acrylic compound 10 | | | | 5.0 | |
| acrylic compound 11 | | | | | 5.0 |
| curing | 4.5 | 4.5 | 4.5 | 4.5 | 4.5 |
| accelerator 2 | | | | | |
| carnauba wax | 2 | 2 | 2 | 2 | 2 |
| carbon black | 1.5 | 1.5 | 1.5 | 1.5 | 1.5 |
| fused silica | 1577 | 1577 | 1542 | 1542 | 1542 |
| acrylic compound | 0.28 | 0.28 | 0.29 | 0.29 | 0.29 |
| in the total components | | | | | |
| (wt %) | | | | | |

TABLE 21
evaluation result 10

| | example | | | | | | | |
|---|---|---|---|---|---|---|---|---|
| evaluation item | 44 | 45 | 46 | 47 | 48 | 49 | 50 | 51 |
| Spiral Flow (cm) | 101 | 100 | 138 | 112 | 103 | 119 | 82 | 125 |
| Disc Flow (mm) | 94 | 96 | 105 | 102 | 97 | 95 | 71 | 97 |
| Hardness at | 83 | 83 | 84 | 83 | 83 | 81 | 79 | 81 |
| Hot Time | | | | | | | | |
| Adhesion Storage | 89 | 90 | 89 | 90 | 91 | 90 | 74 | 75 |
| (%) | | | | | | | | |
| Reflow Soldering | | | | | | | | |
| Resistance | | | | | | | | |
| 24 h | 0/10 | 0/10 | 0/10 | 0/10 | 0/10 | 0/10 | 0/10 | 0/10 |
| 48 h | 0/10 | 0/10 | 0/10 | 0/10 | 0/10 | 0/10 | 0/10 | 4/10 |
| 72 h | 0/10 | 0/10 | 0/10 | 0/10 | 0/10 | 0/10 | 5/10 | 10/10 |
| Water Absorption | 0.14 | 0.14 | 0.14 | 0.15 | 0.14 | 0.14 | 0.16 | 0.16 |
| (%) | | | | | | | | |
| Tg (° C.) | 114 | 113 | 141 | 117 | 114 | 121 | 118 | 125 |
| Flame Retardancy | V-0 | V-0 | V-0 | V-0 | V-0 | V-0 | V-0 | V-0 |

TABLE 22
evaluation result 11

| | example | | | | |
|---|---|---|---|---|---|
| evaluation item | 52 | 53 | 54 | 55 | 56 |
| Spiral Flow (cm) | 98 | 100 | 99 | 99 | 97 |
| Disc Flow (mm) | 93 | 97 | 96 | 95 | 94 |
| Hardness at | 83 | 83 | 83 | 83 | 83 |
| Hot Time | | | | | |
| Adhesion Storage | 88 | 90 | 88 | 88 | 91 |
| (%) | | | | | |
| Reflow Soldering | | | | | |
| Resistance | | | | | |
| 24 h | 0/10 | 0/10 | 0/10 | 0/10 | 0/10 |
| 48 h | 0/10 | 0/10 | 0/10 | 0/10 | 0/10 |
| 72 h | 0/10 | 0/10 | 0/10 | 0/10 | 0/10 |
| Water Absorption | 0.14 | 0.15 | 0.14 | 0.15 | 0.14 |
| (%) | | | | | |
| Tg (° C.) | 113 | 114 | 113 | 114 | 113 |
| Flame Retardancy | V-0 | V-0 | V-0 | V-0 | V-0 |

From Tables 10 to 15, Table 21 and Table 22, the following results were obtained. The products in Examples 1 to 56 which have the same resin composition as in the Comparative Examples except that the acrylic compound (C) is not contained and the silane compound (D) is partially different, show superior characteristics in spiral flow, disc flow, and adhesion storage to those in the Comparative Examples. For example, Comparative Example 2 corresponds in composition to Examples 2, 42, 43, 50 and 51, Comparative Example 7 corresponds in composition to Examples 7, 19, 26, 31, 37 and 45, Comparative Example 12 corresponds in composition to Examples 12, 20, 27, 32, 38 and 46, Comparative Example 13 corresponds in composition to Examples 13, 21, 28, 33, 39 and 47, Comparative Example 15 corresponds in composition to Examples 15, 23, 29, 34, 40 and 48, and Comparative Example 17 corresponds in composition to Examples 17, 24, 35, 41 and 49.

Defects scarcely occurred in the reflow treatment after moisture absorption for 72 hours in Examples 1 to 49 wherein the acrylic compound is contained in the preferable range, that is, 0.03 to 0.8% by mass, and even in the reflow treatment after moisture absorption for 48 hours, the packages in these examples are excellent in reflow soldering resistance without generating cracking. Particularly, excellent fluidity were shown by the products wherein the epoxy resin used was the epoxy resin 2 (biphenyl type epoxy resin) and the curing agent used was the curing agent 2 (phenol-aralkyl resin) as shown in Example 2, 42 or 43, or by the products wherein the epoxy resin 8 (bisphenol F type epoxy resin) was used and the curing agent 1 (phenol-aralkyl resin) and the curing agent 4 (triphenylmethane type phenol resin) were simultaneously used as the curing agent as shown in Example 12, 20, 27, 32, 38 or 46.

High Tg was shown by the products wherein the epoxy resin 1 (o-cresol novolac type epoxy resin) was used as the epoxy resin and the curing agent 5 (novolac type phenol resin) was used as the curing agent as shown in Example 1 or by the products wherein the curing agent 4 (triphenylmethane type phenol resin) was used as the curing agent as shown in Example 5, 10, 12, 20, 27, 32, 38 or 46, and excellent heat resistance was shown particularly in Example 10 wherein the epoxy resin 7 (triphenylmethane type epoxy resin) was used as the epoxy resin.

On the other hand, the Comparative Examples different in composition form that of the present invention do not satisfy the object of the present invention. That is, Comparative Examples 1 to 17 shown in Tables 16 to 18 are poor in fluidity and adhesion storage, and in almost all the comparative examples, 50% or more package cracking occurs in the reflow treatment after moisture absorption for 72 hours, and even in the reflow treatment after moisture absorption for 48 hours, the packages are cracked, thus showing inferior reflow soldering resistance.

### INDUSTRIAL APPLICABILITY

The epoxy resin molding material for sealing, which can be obtained by the present invention, can give an electronic component derive excellent in fluidity and reflow soldering resistance without deteriorating curability, and thus its industrial value is high.

1. An epoxy resin molding material for sealing, comprising an epoxy resin (A), a curing agent (B) and an acrylic compound (C), wherein the acrylic compound (C) is an acrylic compound obtained by polymerizing compounds represented respectively by the following general formulae (I) and (II) in a (I)/(II) mass ratio of from 0 to 10, 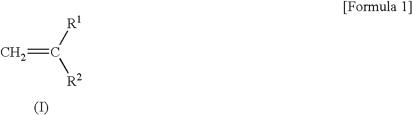
wherein R¹ represents a hydrogen atom or a methyl group, and R² represents a silicon atom-free monovalent organic group, 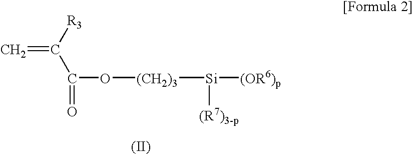
wherein R³ represents a hydrogen atom or a methyl group, R⁶ represents a hydrogen atom or a hydrocarbon group having 1 to 6 carbon atoms, R⁷ represents a hydrocarbon group having 1 to 6 carbon atoms, and p is an integer of 1 to 3.

2. The epoxy resin molding material for sealing according to claim 1, wherein R² in the general formula (I) is a group represented by the general formula (III) below, a —CO—NH₂ group, a —CN group, an alkyl group, an alkenyl group, a cycloalkenyl group, an aryl group, an aldehyde group, a hydroxyalkyl group, a carboxyalkyl group, a hydrocarbon group having 1 to 6 carbon atoms that is bound via an amide structure, a monovalent heterocyclic group, an organic group bound via a divalent or trivalent heteroatom, or a group having a hydrocarbon group bound via a divalent or trivalent heteroatom to an organic group, and may be substituted, 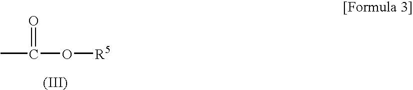
wherein R⁵ represents a hydrogen atom, an alkali metal atom or a substituted or unsubstituted organic group having 1 to 22 carbon atoms.

3. The epoxy resin molding material for sealing according to claim 2, wherein R⁵ in the general formula (III) is a hydrocarbon group wherein at least a part of hydrogen atoms may be substituted by a chlorine atom, a fluorine atom, an amino group, an amine salt, an amido group, an isocyanato group, an alkyloxide group, a glycidyl group, an aziridine group, a hydroxyl group, an alkoxy group, an acetoxy group or an acetacetoxy group.

4. The epoxy resin molding material for sealing according to claim 1 or 2, wherein the compound represented by the general formula (I) is an ester of a substituted or unsubstituted divalent or more alcohol and acrylic acid or methacrylic acid.

5. The epoxy resin molding material for sealing according to any one of claims 1 to 3, wherein the proportion of the acrylic compound (C) in the epoxy resin molding material for sealing is 0.03 to 0.8% by mass.

6. The epoxy resin molding material for sealing according to any one of claims 1 to 3, wherein the epoxy resin (A) comprises at least one member selected from the group consisting of a biphenyl type epoxy resin, thiodiphenol type epoxy resin, novolac type epoxy resin, dicyclopentadiene type epoxy resin, naphthalene type epoxy resin, triphenylmethane type epoxy resin, bisphenol F type epoxy resin, phenol-aralkyl type epoxy resin, and naphthol-aralkyl type epoxy resin.

7. The epoxy resin molding material for sealing according to any one of claims 1 to 3, wherein the curing agent (B) comprises at least one member selected from the group consisting of a phenol-aralkyl resin, naphthol-aralkyl resin, triphenylmethane type phenol resin, novolac type phenol resin, and copolymer type phenol-aralkyl resin.

8. The epoxy resin molding material for sealing according to any one of claims 1 to 3, which further comprises a silane compound (D).

9. The epoxy resin molding material for sealing according to any one of claims 1 to 3, which further comprises a curing accelerator (E).

10. The epoxy resin molding material for sealing according to any one of claims 1 to 3, which further comprises an inorganic filler (F).

11. An electronic component device comprising an element sealed with the epoxy resin molding material for sealing according to any one of claims 1 to 3.
